(19) United States
(12) Patent Application Publication
(10) Pub. No.: US 2026/0313437 A1
(43) Pub. Date: Oct. 8, 2026

(54) ENABLING PROTOCOL DATA UNIT SET-BASED DATA COMMUNICATION

(71) Applicant: GOOGLE LLC, Mountain View, CA (US)

(72) Inventor: Chih-Hsiang Wu, Taoyuan City (TW)

(21) Appl. No.: 19/481,845

(22) PCT Filed: May 5, 2024
(86) PCT No.: PCT/US2024/027906

§ 371 Date: Nov. 5, 2025

Related U.S. Application Data
(60) Provisional application No. 63/500,569, filed on May 5, 2023.
(60) Provisional application No. 63/469,360, filed on May 26, 2023.

(51) Int. Cl. H04W 28/02; H04W 72/543

(52) U.S. Cl. CPC H04W 28/0268; H04W 28/0236; H04W 72/543

(57) ABSTRACT

A radio access network (RAN) node configures protocol data unit (PDU) quality of service (QOS). To this end, the RAN node receives (502), at a control plane (CP) entity of the RAN node from a core network (CN), first QoS parameters for a PDU set, for delivery to a UE; and provides (506 ), by the CP entity to a user plane (UP) entity of the RAN node, second QoS parameters based on the first QoS parameters.

This application claims priority to and the benefit of the filing date of provisional U.S. Patent Application No. 63/500,569 entitled “Enabling Protocol Data Unit Set-Based Data Communication,” filed on May 5, 2023, and provisional U.S. Patent Application No. 63/469,360 entitled “Enabling Protocol Data Unit Set-Based Data Communication,” filed on May 26, 2023. The entire content of these provisional applications is hereby expressly incorporated herein by reference.

### FIELD OF THE DISCLOSURE

This disclosure relates to wireless communications and, more particularly, to enabling protocol data unit (PDU) Set communication.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer. A core network communicates data with the UE via the RAN using multiple layers of a protocol stack.

XR stands for extended Reality, which is an umbrella term that covers Augmented Reality (AR), Virtual Reality (VR), and Mixed Reality (MR). In virtual reality, the user is fully immersed in a virtual environment that is totally substituting the real environment (e.g., by wearing a head-mounted device). Augmented reality augments the perception of the real environment with some virtual elements, so some virtual elements are overlaid on the perception of the real environment. Mixed reality is an extension of AR where the real and virtual elements interact in real time. Cloud gaming runs video games on remote servers without the need for a gaming console or a high spec CPU and GPU to play such games. Cloud gaming streams a game like streaming a video, and the game will respond to commands and controls in real time.

XR services and cloud gaming require high data rate and low latency transmission. As such, new quality of service requirements are used to support XR services and cloud gaming. However, it is not clear how to support the new quality of service requirements for protocol data unit (PDU) sets in a disaggregated base station including a centralized unit-control plan function (CU-CP), a centralized unit-user plane function (CU-UP), and a distributed unit (DU).

### SUMMARY

An example embodiment of the techniques of this disclosure is a method in a radio access network (RAN) node for configuring protocol data unit (PDU) quality of service (QOS).

The method comprises receiving, at a control plane (CP) entity of the RAN node from a core network (CN), first QoS parameters for a PDU set to be delivered to a UE; and providing, by the CP entity to a user plane (UP) entity of the RAN node, second QoS parameters based on the first QoS parameters.

Another example embodiment of the techniques of this disclosure is method in a radio access network (RAN) node for configuring protocol data unit (PDU) quality of service (QOS).

The method comprises receiving, at a user plane (UP) entity of the RAN node from a control plane (CP) entity, QoS parameters for a PDU set to be delivered to a UE; and assigning resources for communicating PDU packets between the UE and a core network (CN) according to the QoS parameters

Yet another example embodiment of these techniques is a RAN node comprising a transceiver and processing hardware configured to implement the method above.

### BRIEF DESCRIPTION OF THE DRAWINGS

FIG. 1A is a block diagram of an example wireless communication system in which a user device and a base station of this disclosure implement the techniques of this disclosure for managing PDU Set;

FIG. 1B is a block diagram of an example base station including a central unit (CU) and a distributed unit (DU) that operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is an example message sequence in which a CN transmits PDU Set QoS parameters to a CU-CP, which transmits the PDU Set related information to a CU-UP to perform PDU Set handing for data communication between the CU-UP and a DU;

FIG. 4 is a flow diagram of an example method implemented in a CU-CP for transmitting parameters to a CU-UP to enable PDU Set-based QoS handling for a UE;

FIG. 5A is a flow diagram of an example method implemented in a CU-CP for determining whether to include a second set of parameters in a message based on whether the CU-CP receives a first set of parameters;

FIG. 5B is a flow diagram of an example method similar to FIG. 5A, but in which the CU-CP makes the determination based additionally on whether the UE and/or CU-UP support PDU Set-based QoS handling;

FIG. 6A is a flow diagram of an example method implemented in a CU-UP for receiving parameters for a UE from a CU-CP and communicating data with a CN using PDU information;

FIG. 6B is a flow diagram of an example method similar to FIG. 6A, but in which the CU-UP determines whether to use the PDU information to communicate data based on whether the message from the CU-CP includes the parameters;

FIG. 7A is a flow diagram of an example method similar to FIG. 6A, but in which the CU-UP communicates data with a DU rather than the CN;

FIG. 7B is a flow diagram of an example method similar to FIG. 6B, but in which the CU-UP communicates data with a DU rather than the CN;

FIG. 8A is a flow diagram of an example method implemented in a CU-UP for determining whether to enable PDU Set-based QoS handling based on whether a message includes PDU Set QoS parameters;

FIG. 8B is a flow diagram of an example method similar to FIG. 8A, but in which the CU-UP makes the determination based additionally on whether the UE and/or CU-UP support PDU Set-based QoS handling;

FIG. 9A is a flow diagram of an example method implemented in a CU-UP for receiving and transmitting a data packet and PDU Set information;

FIG. 9B is a flow diagram of an example method similar to FIG. 9A, but in which the CU-UP generates and transmits second PDU Set information;

FIG. 10A is a flow diagram of an example method implemented in a CU-UP for determining whether to generate and transmit a data packet including PDU Set information based on whether a received packet includes the information;

FIG. 10B is a flow diagram of an example method similar to FIG. 10A, but in which the CU-UP generates second PDU Set information based on the first PDU Set information; and

FIG. 11 is a flow diagram of an example method implemented in a CU-UP for receiving PDU Set information from a CN and refraining from transmitting the PDU Set information to a DU.

### DETAILED DESCRIPTION OF THE DRAWINGS

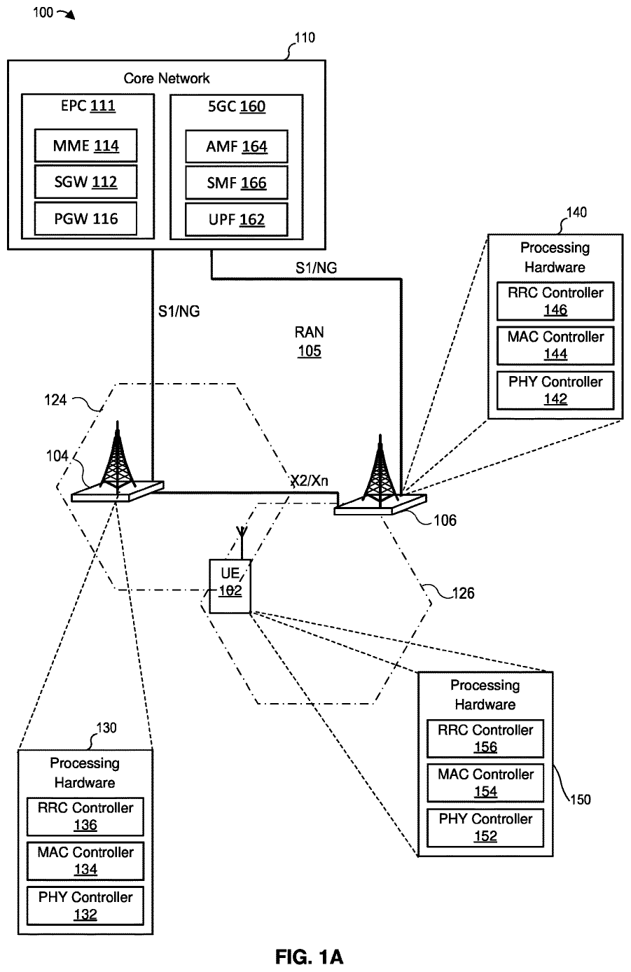

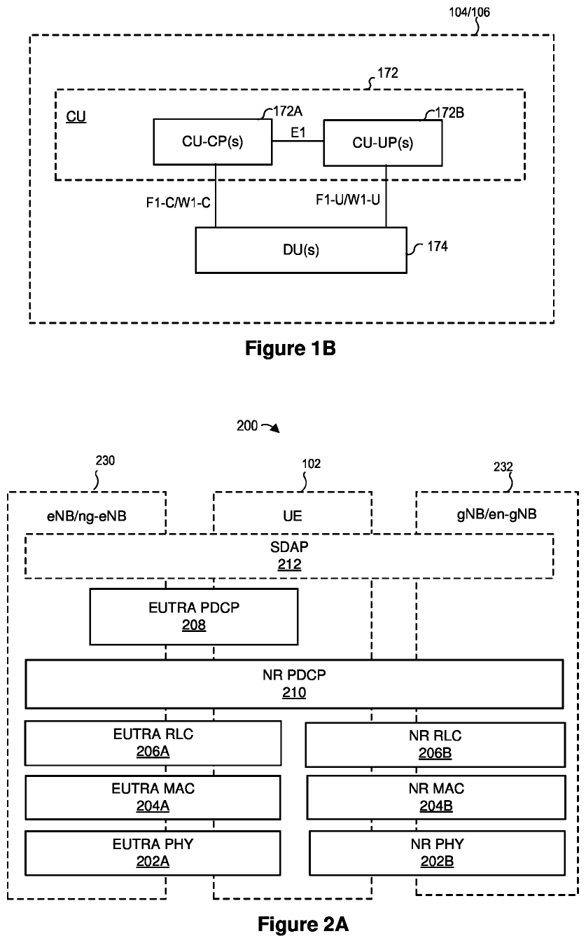

FIG. 1A depicts an example wireless communication system 100 in which communication devices can implement these techniques. The wireless communication system 100 includes a UE 102, a base station (BS) 104, a base station 106 and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, a MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. In some implementations, when the base station 104 is an MgNB and the base station 106 is an SgNB, the UE 102 is in NR-NR DC (NR-DC) with the MgNB and the SgNB. In further implementations, when the base station 104 is an MgNB and the base station 106 is a Secondary ng-eNB (Sng-eNB), the UE 102 is in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an SI interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

As illustrated in FIG. 1A, the base station 104 supports cell 124, and the base station 106 supports a cell 126. The cells 124 and 126 can partially overlap, so that the UE 102 can communicate in DC with the base station 104 and the base station 106, where one of the base stations 104 and 106 is an MN and the other is an SN. The base station 104 and base station 106 can support additional cell(s) (not shown in FIG. 1A). The base station 104 can operate the cells 124 and/or additional cell(s) via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include a RLC controller (not show in FIG. 1A) configured to perform RLC functions with one or more user devices. The processing hardware 130 can further include a PDCP controller (not show in FIG. 1A) configured to perform PDCP functions with one or more user devices. The processing hardware 130 can further include an RRC controller 136 to implement procedures and messaging at the RRC sublayer of the protocol communication stack. For example, the RRC controller 136 is configured to support RRC messaging associated with resource configuration and reconfiguration procedure, handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing for communication with the base station 104 or 106, and communicating UL/DL MAC PDUs with the base station 104 or 106. The processing hardware 150 can further include an RRC controller 156 to implement procedures and messaging at the RRC sublayer of the protocol communication stack. The processing hardware 150 can further include a RLC controller (not show in FIG. 1A) configured to perform RLC functions with the base station 104 or 106. The processing hardware 150 can further include a PDCP controller (not show in FIG. 1A) configured to perform PDCP functions with the base station 104 or 106.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example, distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include an RRC controller such as RRC controller 136, 146. The CU 172 can a PDCP controller and/or a SDAP controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the El interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

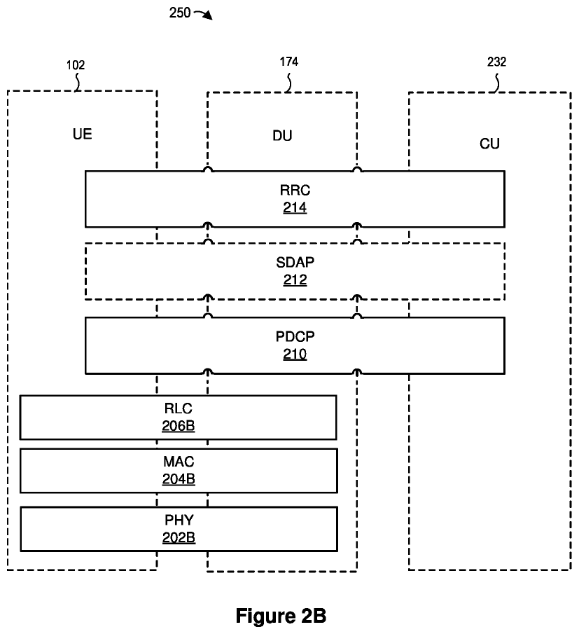

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

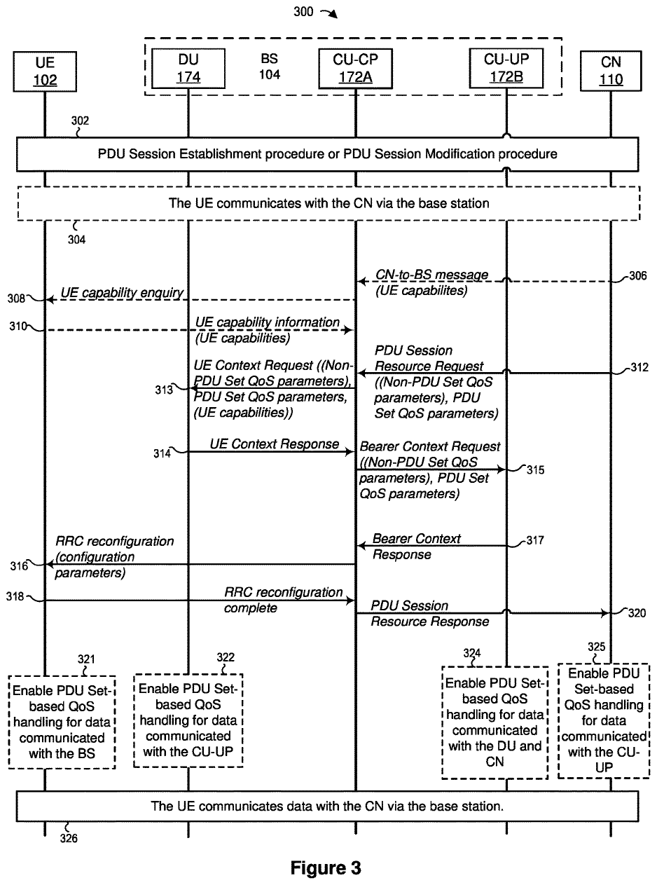

Referring first to FIG. 3, in a scenario 300, the base station 104 includes a CU-CP 172A, a CU-UP 172B, and a DU 174. Initially, the UE 102 performs 302 a PDU Session Establishment procedure or a PDU Session Modification procedure with the CN 110 via the base station 104 (e.g., CU-CP 172A and DU 174) or the base station 106 (not show in FIG. 3) to establish or modify a PDU session for performing one or more services. In some implementations, the service(s) require high data rate and low latency transmission, such as XR services and/or cloud games. In some implementations, the UE 102 performs 302 the PDU Session Establishment procedure or PDU Session Modification procedure with the SMF 166 via the AMF 164 and the base station 104 or 106.

In the PDU Session Establishment procedure, the UE 102 transmits a PDU Session Establishment Request message to the CN 110 via the base station (e.g., the base station 104 or 106). In some implementations, in response, the CN 110 sends a PDU Session Establishment Accept message to the CN 110 via the base station. In response to the PDU Session Establishment Accept message, the UE 102 then transmits a PDU Session Establishment Complete message to the CN 110 via the base station. In the PDU Session Modification procedure, the UE 102 transmits a PDU Session Modification Request message to the CN 110 via the base station. In further implementations, in response, the CN 110 sends a PDU Session Modification Command message to the CN 110 via the base station. In response to the PDU Session Modification Command message, the UE 102 then transmits a PDU Session Modification Complete message to the CN 110 via the base station.

In some implementations, the UE 102 includes, in the PDU Session Establishment Request message or PDU Session Modification Request message, a PDU session ID identifying the PDU session, slice information, and/or a particular data network name (DNN). In further implementations, the CN 110 includes the PDU session ID in the PDU Session Establishment Accept message or PDU Session Modification Command message to indicate that the PDU session is established or modified successfully. In some implementations, the slice information indicates a specific slice configured for the service(s). For example, the slice information is a Single Network Slice Selection Assistance Information (S-NSSAI) or includes a portion of the S-NSSAI. In other implementations, the UE 102 includes, in the PDU Session Establishment Request message or PDU Session Modification Request message, UE-requested quality of service (QOS) parameters that the UE 102 uses to perform the service(s).

After performing the procedure 302, the UE 102 communicates 304 with the CN 110 via the base station 104 (e.g., the CU-CP 172A, CU-UP 172B and DU 174). In some implementations, while communicating with the UE 102, the CU-CP 172A receives 306 a CN-to-BS message including UE capabilities of the UE 102 from the CN 110. In further implementations, the CU-CP 172A transmits a CU-to-DU message including the UE capabilities to the DU 174. Depending on the implementation, the CU-to-DU message is an F1Application Protocol (FIAP) message, a UE Context Setup Request message, or a UE Context Modification Request message. Alternatively, the CU-CP 172A transmits 308 a UE capability enquiry message to the UE 102 via the DU 174 to enquire about the UE capabilities. In response, the UE 102 transmits 310 a UE capability information message, including the UE capabilities, to the CU-CP 172A via the DU 174. In some implementations, the UE capabilities include (new) capabilities indicating support of one or more functions/features for enhancing communication of data requiring high data rate and low latency, such as XR data or cloud gaming data. For example, the function(s)/feature(s) include multiple configured grant (CG) Physical Uplink Shared Channel (PUSCH) transmission occasions in a period of a single CG PUSCH configuration, dynamic indication of unused CG PUSCH occasion(s) based on uplink control information (UCI) by the UE 102, buffer status reporting (BSR) enhancements including at least new buffer status table(s), delay of reporting of buffered data in uplink, provision of XR traffic assistance information for DL and UL (e.g., periodicity), and/or PDU Set-based QoS handling (e.g., discard operation of PDU Set(s)). A PDU Set includes one or more PDUs carrying a payload of a unit of information generated at the application level (e.g., frame(s), video slice(s), etc., for XR services).

During or after the procedure 302 or the communication 304, the CN 110 transmits 312 a PDU Session Resource Request message to the CU-CP 172A to request the CU-CP 172A to assign resources for the PDU session and one or more QoS flows for the UE 102. The QoS flow(s) are associated with the PDU session. In some implementations, the CN 110 includes a first set of PDU Set QoS parameters for the PDU session or the QoS flow(s) in the PDU Session Resource Request message. In one implementation, the CN 110 includes a first set of PDU Set QoS parameters to request or configure PDU Set-based QoS handling for the PDU session or the QoS flow(s). After (e.g., in response to) receiving the PDU Session Resource Request message, the CU-CP 172A transmits 313 a UE Context Request message for the PDU session or QoS flow(s) to the DU 174. In some implementations, the CU-CP 172A includes a second set of PDU Set QoS parameters in the UE Context Request message to request or configure PDU Set-based QoS handling for the PDU session or the QoS flow(s).

In some implementations, the second set of PDU Set QoS parameters is the same as the first set of PDU Set QoS parameters. In other implementations, the second set of PDU Set QoS parameters is different from the first set of PDU Set QoS parameters. In some implementations, the CU-CP 172A determines the second set of PDU Set QoS parameters based on the first set of PDU Set QoS parameters. In such cases, the CU-CP 172A ensures that the second set of PDU Set QoS parameters satisfies the first set of PDU Set QoS parameters. In some examples, the CU-CP 172A determines the second set of PDU Set QoS parameters more stringently than for the first set of PDU Set QoS parameters by considering latency in a F1-U connection between the CU-UP 172B and DU 174, data processing time at the CU-UP 172B, and/or data processing time at the DU 174. In further examples, the CU-CP 172A determines the second set of PDU Set QoS parameters similarly to the first set of PDU Set QoS parameters, as the first set of PDU Set QoS parameters already take into account such factors as latency in the F1-U connection, data processing time, etc.

In some implementations, the CU-CP 172A determines to include or includes the second set of PDU Set QoS parameters in the UE Context Request message (e.g., event 313) if the CU-CP 172A, the CU-UP 172B, and/or DU 174 support(s) PDU Set-based QoS handling. If the CU-CP 172A, CU-UP 172B, and/or DU 174 do not support PDU Set-based QoS handling, the CU-CP 172A does not include PDU Set QoS parameters (e.g., the second set of PDU Set QoS parameters) in the UE Context Request message. In other implementations, the CU-CP 172A determines to include or includes the second set of PDU Set QoS parameters in response to receiving at least one of the (new) capabilities. In some implementations, if the UE capabilities do not include the (new) capability or capabilities, the CU-CP 172A does not include the second set of PDU Set QoS parameters in the UE Context Request message.

In some implementations, the CN 110 includes a corresponding set of PDU Set QoS parameters for each of the QoS flow(s) indicated in the PDU Session Resource Request message (e.g., event 312). In some such cases, the CU-CP 172A includes a corresponding set of PDU Set QoS parameters in the UE Context Request message (e.g., event 313). In some implementations, for each of the QoS flow(s), the corresponding set of PDU Set QoS parameters in the UE Context Request message is the same as the corresponding set of PDU Set QoS parameters in the PDU Session Resource Request message. In other implementations, for each of the QoS flow(s), the CU-CP 172A determines the corresponding set of PDU Set QoS parameters in the UE Context Request message based on the corresponding set of PDU Set QoS parameters in the PDU Session Resource Request message.

In some implementations, the CN 110 includes, in the PDU Session Resource Request message (e.g., event 312), a first set of non-PDU Set QoS parameters (e.g., QoS parameter(s) not related to a PDU Set). In some such cases, the CU-CP 172A includes a second set of non-PDU Set QoS parameters in the UE Context Request message (e.g., event 313). In some implementations, the second set of non-PDU Set QoS parameters is the same as the first set of non-PDU Set QoS parameters. In other implementations, the CU-CP 172A determines the second set of non-PDU Set QoS based on the first set of non-PDU Set QoS parameters. In some implementations, the CN 110 includes a corresponding set of non-PDU Set QoS parameter(s) for each of the QoS flow(s) in the PDU Session Resource Request message (e.g., event 312). In some such cases, the CU-CP 172A includes a corresponding set of non-PDU Set QoS parameters for each of the QoS flow(s) in the UE Context Request message (e.g., event 313). In some implementations, for each of the QoS flow(s), the corresponding set of non-PDU Set QoS parameters in the UE Context Request message is the same as the corresponding set of non-PDU Set QoS parameters in the PDU Session Resource Request message. In other implementations, for each of the QoS flow(s), the CU-CP 172A determines the corresponding set of non-PDU Set QoS parameters in the UE Context Request message based on the corresponding set of non-PDU Set QoS parameters in the PDU Session Resource Request message. In other implementations, the CN 110 does not include, in the PDU Session Resource Request message, non-PDU Set QoS parameters for the PDU session or QoS flow(s). In some such cases, the CU-CP 172A does not include, in the UE Context Request message, non-PDU Set QoS parameters for the PDU session or QoS flow(s).

In some implementations, a set of non-PDU Set QoS parameters (e.g., as described above) includes a QoS identifier descriptor, a maximum flow bit rate for DL, a maximum flow bit rate for UL, a guaranteed flow bit rate for DL, and/or a guaranteed flow bit rate for UL.

In some implementations, the CN 110 includes a PDU Session ID identifying the PDU session in the PDU Session Resource Request message (e.g., event 312). In some implementations, the CN 110 includes one or more QoS flow identifiers identifying the QoS flow(s) in the PDU Session Resource Request message. Each of the QoS flow identifier(s) identifies a particular QoS flow of the QoS flow(s). In some implementations, the CU-CP 172A includes the QoS flow identifier(s) in the UE Context Request message (e.g., event 313) and associates the QoS flow identifier(s) with the corresponding set of the PDU Set QoS parameters and/or non-PDU Set QoS parameters.

In response to receiving 313 the UE Context Request message, the DU 174 transmits 314 a UE Context Response message to the CU-CP 172A. In some implementations, the DU 174 assigns resources for the PDU Session or QoS flow(s), generates DU configuration parameters for communicating data associated with the PDU session or QoS flow(s), and includes the DU configuration parameters in the UE Context Response message (e.g., event 314). In some implementations, if the DU 174 supports PDU Set-based QoS handling or the second set of PDU Set QoS parameters, the DU 174 includes, in the UE Context Response message, confirmation information indicating that the DU 174 applies (e.g., performs) PDU Set-based QoS handling (e.g., for the PDU session or QoS flow(s)), based on the second set of PDU Set QoS parameters. In other implementations, if the DU 174 does not support PDU Set-based QoS handling or the second set of PDU Set QoS parameters, the DU 174 includes unsupported information (e.g., a cause or value) in the UE Context Response message to indicate that the DU 174 does not support PDU Set-based QoS handling or the second set of PDU Set QoS parameters. In some alternative implementations, the DU 174 implicitly indicates that the DU 174 supports PDU Set-based QoS handling or the second set of PDU Set QoS parameters by excluding the unsupported information in the UE Context Response message.

In some implementations, if the DU 174 supports the second set of PDU Set QoS parameters or PDU Set-based QoS handling, the DU 174 assigns resources for the PDU Session or QoS flow(s) and/or generates some or all of the configuration parameters based on the second set of PDU Set QoS parameters. In some implementations, if the UE 102 and/or DU 174 support(s) the second set of PDU Set QoS parameters or PDU Set-based QoS handling, the DU 174 enables 322 PDU Set-based QoS handling (e.g., for the PDU session or QoS flow(s)). In some implementations, the DU 174 enables 322 PDU Set-based QoS handling after (e.g., in response to) receiving the second set of PDU Set QoS parameters or the UE Context Request message. In further implementations, the DU 174 enables 322 PDU Set-based QoS handling (e.g., for the PDU session or QoS flow(s)), regardless of when the DU 174 receives the second set of PDU Set QoS parameters or the UE Context Request message.

In some implementations, if the UE 102 and/or DU 174 support(s) PDU Set-based QoS handling, and/or the UE Context Request message includes PDU Set QoS parameters (e.g., the second set of PDU Set QoS parameters), the DU 174 includes, in the DU configuration parameters, at least one configuration parameter for PDU Set-based QoS handling. In some implementations, the DU 174 additionally considers the second set of non-PDU Set QoS parameters when configuring the configuration parameters and/or assigning resources for the UE 102. In other implementations, the DU 174 ignores the second set of non-PDU Set QoS parameters when configuring the configuration parameters and/or assigning resources for the UE 102. By properly assigning resources for the UE 102 and/or configuring the configuration parameters, the DU 174 ensures that the UE 102 receives the data associated with the PDU session or QOS flow(s) in compliance with the second set of PDU Set QoS parameters and/or the second set of non-PDU Set QoS parameters in the event 326. In some implementations, if the UE 102 and/or DU 174 support(s) PDU Set-based QoS handling and/or the UE Context Request message includes PDU Set QoS parameters (e.g., the second set of PDU Set QoS parameters), the DU 174 configures the at least one configuration parameter. Otherwise, if the UE 102 and/or DU 174 do(es) not support PDU Set-based QoS handling and/or the UE Context Request message does not include PDU Set QoS parameters, the DU 174 does not include the at least one configuration parameter in the configuration parameters 314. In such cases, the UE 102 does not enable or disables PDU Set-based QoS handling in response to receiving the configuration parameters excluding the at least one configuration parameter.

In other implementations, if the UE 102 and/or DU 174 do not support the second set of PDU Set QoS parameters or PDU Set-based QoS handling, the DU 174 assigns resources for the PDU Session or QoS flow(s) and/or generates the configuration parameters, based on the second set of non-PDU Set QoS parameters. If the UE 102 and/or DU 174 do not support the second set of PDU Set QoS parameters or PDU Set-based QoS handling, and the UE Context Request message does not include non-PDU Set QoS parameters, the DU 174, based on predefined QoS parameters, assigns resources for the PDU Session or QoS flow(s) and/or generates the configuration parameters. In such implementations, the configuration parameters exclude the at least one configuration parameter configuring PDU Set-based QoS handling. By properly assigning resources and/or configuring the configuration parameter(s) for the UE 102, the DU 174 ensures that the UE 102 receives the data associated with the PDU session or QoS flow(s) in compliance with the second set of non-PDU Set QoS parameters or predefined QoS parameters in the event 326.

In some implementations, the CU-CP 172A includes the UE capabilities in the UE Context Request message 313. In other implementations, the CU-CP 172A transmits another CU-to-DU message, including the UE capabilities, to the DU 174. In response, the DU 174 transmits a DU-to-CU message to the CU-CP 172A. In some implementations, the CU-to-DU message and DU-to-CU message are a UE Context Setup Request message and a UE Context Setup Response message, respectively. Thus, the DU 174 determines whether the UE 102 supports PDU Set-based QoS handling based on the UE capabilities.

The UE Context Request message and UE Context Response message form a UE Context procedure (e.g., a UE Context Setup procedure or a UE Context Modification procedure). In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively. In some alternative implementations, the DU 174 includes the configuration parameters in a UE Context Modification Required message instead of the UE Context Response message and transmits the UE Context Modification Required message to the CU-CP 172A. In some such cases, the CU-CP 172A transmits a UE Context Modification Confirm message to the DU 174 in response to the UE Context Modification Required message.

After receiving 312 the PDU Session Resource Request message, transmitting 313 the UE Context Request message, or receiving 314 UE Context Response message, the CU-CP 172A performs a Bearer Context procedure with the CU-UP 172B to establish or modify a bearer context for the UE 102. In the Bearer Context procedure, the CU-CP 172A transmits 315 a Bearer Context Request message for the UE 102 (e.g., for the PDU session or QoS flow(s)) to the CU-UP 172B and, in response, the CU-UP 172B transmits 317 a Bearer Context Response message to the CU-CP 172A. In some implementations, the CU-CP 172A includes a third set of PDU Set QoS parameters for the UE 102 (e.g., for the PDU session or QoS flow(s)) in the Bearer Context Request message (e.g., event 315) to request or configure PDU Set-based QoS handling for the PDU session or QoS flow(s). In some implementations, the third set of PDU Set QoS parameters is the same as the first or second set of PDU Set QoS parameters. In other implementations, the third set of PDU Set QoS parameters is different from the first set of PDU Set QoS parameters and/or the second set of PDU Set QoS parameters. In some implementations, the CU-CP 172A determines the third set of PDU Set QoS parameters based on the first set of PDU Set QoS parameters. In such cases, the CU-CP 172A ensures that the third set of PDU Set QoS parameters satisfies the first set of PDU Set QoS parameters. For example, the CU-CP 172A determines the third set of PDU Set QoS parameters more stringent than the first set of PDU Set QoS parameters, considering latency in a F1-U connection between the CU-UP 172B and DU 174, data processing time at the CU-UP 172B, and/or data processing time at the DU 174. In further examples, the CU-CP 172A determines the third set of PDU Set QoS parameters similarly to the first set of PDU Set QoS parameters, as the first set of PDU Set QoS parameters already take into account such factors as latency in the F1-U connection, data processing time, etc. Depending on the implementation, the third set of PDU Set QoS parameters are the same as the second set of PDU Set QoS parameters.

In some implementations, the CU-CP 172A determines to include or includes the third set of PDU Set QoS parameters in the Bearer Context Request message (e.g., event 315), such as if the CU-CP 172A and/or CU-UP 172B support(s) PDU Set-based QoS handling. If the CU-CP 172A and/or CU-UP 172B do not support PDU Set-based QoS handling, the CU-CP 172A does not include PDU Set QoS parameters (e.g., the third set of PDU Set QoS parameters) in the Bearer Context Request message. In other implementations, the CU-CP 172A determines to include or includes the third set of PDU Set QoS parameters in the Bearer Context Request message in response to receiving at least one of the (new) capabilities. In further implementations, if the UE capabilities do not include the (new) capability/capabilities, the CU-CP 172A does not include the third set of PDU Set QoS parameters in the Bearer Context Request message.

In some such cases where the CN 110 includes a corresponding set of PDU Set QoS parameters for each of the QoS flow(s) indicated in the PDU Session Resource Request message (e.g., event 312), the CU-CP 172A includes a corresponding set of PDU Set QoS parameters in the Bearer Context Request message (e.g., event 315). In some implementations, for each of the QoS flow(s), the corresponding set of PDU Set QoS parameters in the Bearer Context Request message is the same as the corresponding set of PDU Set QoS parameters in the PDU Session Resource Request message. In other implementations, for each of the QoS flow(s), the CU-CP 172A determines the corresponding set of PDU Set QoS parameters in the Bearer Context Request message, based on the corresponding set of PDU Set QoS parameters in the PDU Session Resource Request message, similar to determining the third set of PDU Set QoS parameters as described above.

In some such cases where the CN 110 includes, in the PDU Session Resource Request message (e.g., event 312), the first set of non-PDU Set QoS parameters (e.g., QoS parameter(s) not related to a PDU Set), the CU-CP 172A includes a third set of non-PDU Set QoS parameters in the Bearer Context Request message (e.g., event 315). In some implementations, the third set of non-PDU Set QoS parameters is the same as the first set of non-PDU Set QoS parameters. In other implementations, the CU 172 determines the third set of non-PDU Set QoS based on the first set of non-PDU Set QoS parameters. In some implementations, the CN 110 includes a corresponding set of non-PDU Set QoS parameter(s) for each of the QoS flow(s) in the PDU Session Resource Request message. In some such cases, the CU 172 includes a corresponding set of non-PDU Set QoS parameters for each of the QoS flow(s) in the Bearer Context Request message. In some implementations, for each of the QoS flow(s), the corresponding set of non-PDU Set QoS parameters in the Bearer Context Request message is the same as the corresponding set of non-PDU Set QoS parameters in the PDU Session Resource Request message. In other implementations, for each of the QoS flow(s), the CU-CP 172A determines the corresponding set of non-PDU Set QoS parameters in the Bearer Context Request message based on the corresponding set of non-PDU Set QoS parameters in the PDU Session Resource Request message. In other implementations, the CN 110 does not include, in the PDU Session Resource Request message, non-PDU Set QoS parameters for the PDU session or QoS flow(s). In some such cases, the CU 172 does not include, in the Bearer Context Request message, non-PDU Set QoS parameters for the PDU session or QoS flow(s).

In some implementations, a set of non-PDU Set QoS parameters (e.g., as described above) includes a QoS identifier descriptor, a maximum flow bit rate for DL, a maximum flow bit rate for UL, a guaranteed flow bit rate for DL, and/or a guaranteed flow bit rate for UL. In some implementations, the CU-CP 172A includes the QoS flow identifier(s) in the Bearer Context Request message and associates the QoS flow identifier(s) with the corresponding set of the PDU Set QoS parameters and/or non-PDU Set QoS parameters. In some implementations, the CU-CP 172A includes the PDU Session ID in the Bearer Context Request message (e.g., event 315).

In some implementations, the CU-UP 172B assigns resources for the PDU Session or QoS flow(s) in accordance with the Bearer Context Request message. In some implementations, the CU-UP 172B applies one or more configurations in the Bearer Context Request message to communicate data with the DU 174 and UE 102, where the data is associated with the PDU session or QoS flow(s). In some implementations, if the CU-UP 172B supports PDU Set-based QoS handling or the third set of PDU Set QoS parameters, the CU-UP 172B includes, in the Bearer Context Response message (e.g., event 315), confirmation information indicating that the CU-UP 172B applies (e.g., performs) PDU Set-based QoS handling based on the third set of PDU Set QoS parameters. In other implementations, if the CU-UP 172B does not support PDU Set-based QoS handling or the third set of PDU Set QoS parameters, the CU-UP 172B includes unsupported information (e.g., a cause or value) in the Bearer Context Response message (e.g., event 317) to indicate that the CU-UP 172B does not support PDU Set-based QoS handling or the third set of PDU Set QoS parameters. In some alternative implementations, the CU-UP 172B implicitly indicates that the CU-UP 172B supports PDU Set-based QoS handling or the third set of PDU Set QoS parameters, such as by excluding the unsupported information in the Bearer Context Response message.

In some implementations, if the CU-UP 172B supports the third set of PDU Set QoS parameters or PDU Set-based QoS handling, the CU-UP 172B assigns resources for the PDU session or QoS flow(s), based on the third set of PDU Set QoS parameters. In some implementations, if the CU-UP 172B supports the third set of PDU Set QoS parameters or PDU Set-based QoS handling, the CU-UP 172B enables 324 PDU Set-based QoS handling. In some implementations, the CU-UP 172B enables 324 PDU Set-based QoS handling for the UE 102 (e.g., for the PDU session or QoS flow(s)), after (e.g., in response to) receiving the third set of PDU Set QoS parameters or the Bearer Context Request message. In other implementations, the CU-UP 172B enables 324 PDU Set-based QoS handling, regardless of when the CU-UP 172B receives the third set of PDU Set QoS parameters or the Bearer Context Request message. In some implementations, the CU-UP 172B additionally considers the third set of non-PDU Set QoS parameters when configuring the configuration parameter(s) and/or assigning resources for the UE 102. In other implementations, the CU-UP 172B ignores the third set of non-PDU Set QoS parameters. By properly assigning resources for the UE 102 and/or configuring the configuration parameter(s), the CU-UP 172B ensures that the DU 174 and/or UE 102 receives the data associated with the PDU session or QoS flow(s) in compliance with the third or corresponding set of PDU Set QoS parameters and/or third or corresponding set of non-PDU Set QoS parameters in the event 326.

In other implementations, if the CU-UP 172B does not support the third set of PDU Set QoS parameters or PDU Set-based QoS handling, the CU-UP 172B assigns resources for the PDU Session or QoS flow(s) based on the third set of non-PDU Set QoS parameters. If the CU-UP 172B does not support the third set of PDU Set QoS parameters or PDU Set-based QoS handling and the Bearer Context Request message does not include non-PDU Set QoS parameters, the CU-UP 172B assigns resources for the PDU Session or QoS flow(s) based on predefined QoS parameters (e.g., non-PDU Set QoS parameters). By properly assigning resources for the UE 102, the CU-UP 172B ensures that the DU 174 and/or the UE 102 receives the data associated with the PDU session or QoS flow(s) in compliance with the third set of non-PDU Set QoS parameters and/or the predefined QoS parameters in the event 326.

In some implementations, the Bearer Context Request message and the Bearer Context Response message are a Bearer Context Setup Request message and a Bearer Context Setup Response message, respectively. In other implementations, the Bearer Context Request message and the Bearer Context Response message are a Bearer Context Modification Request message and a Bearer Context Modification Response message, respectively.

In some implementations, the first, second, and/or third set(s) of PDU Set QoS parameters include(s) PDU Set Delay Budget (PSDB), PDU Set Error Rate (PSER), and/or PDU Set Integrated Handling Information (PSIHI). Depending on the implementation, the PSDB defines an upper bound for a delay time that a PDU Set experiences or is predicted to experience for the transfer between the UE 102 and the CN 110 (e.g., the UPF 162). In some implementations, for DL, the delay time is a time duration between the reception time of the first PDU of a DL PDU Set at the CN 110 (e.g., the UPF 162) and the time when the UE 102 successfully receives all PDUs of the DL PDU Set. In further implementations, for UL, the delay time is a time duration between the reception time of the first PDU of a UL PDU Set at the UE 102 (e.g., the reception time where a protocol layer of the UE 102 receives the first PDU from an application) and the time when the CN 110 (e.g., the UPF 162) successfully receives all PDUs of the UL PDU Set. Depending on the implementation, the protocol layer is the SDAP 212, PDCP 210, RLC 206, or MAC 204. In some implementations, the application is an operating system (e.g., Android, iOS, Windows, or Linux). In some implementations, the PSDB applies to a DL PDU Set for the UE 102 received by the CN 110 (e.g., the UPF 162), and applies to the UL PDU Set sent by the UE 102. The PSER defines an upper bound for a rate of PDU Sets that a sender (e.g., the UE 102, CU 172, or DU 174) of a link layer protocol (e.g., RLC 206) has processed, but that a corresponding receive does not successfully deliver to an upper layer (e.g., PDCP 210) of the receiver. Thus, the PSER defines an upper bound for a rate of non-congestion related PDU Set losses. In some such implementations, the PSER therefore allows for appropriate link layer protocol configurations (e.g., PDCP configuration, RLC bearer configuration, MAC configuration, and/or HARQ configuration) in the configuration parameters. The PSIHI indicates whether all PDUs (e.g., data packets) of a PDU Set are needed for the usage of the PDU Set by the application layer in a receiver. If the PDU Set is a DL PDU Set, the receiver is the UE 102. If the PDU Set is a UL PDU Set, the receiver is the DU 174, CU-UP 172B, or CN 110. In some implementations, the CU-UP 172B or DU 174 determines whether to discard a PDU Set associated with the PDU session or QoS flow(s) based on the PSIHI and PSDB. For example, if the CU-UP 172B or DU 174 determines that transmission of a PDU Set exceeds the PSDB, and the PSIHI indicates that the application layer in the UE 102 uses the PDU Set via all PDUs of a PDU Set, the CU-UP 172B or DU 174 discards the PDU Set.

Otherwise, the CU-UP 172B or DU 174 does not discard the PDU Set and transmits the PDU Set to the DU 174 or UE 102.

After (e.g., in response to) receiving the UE Context Response message or UE Context Modification Required message, the CU-CP 172A transmits 316 an RRC reconfiguration message to the UE 102 via the DU 174. In response, the UE 102 transmits 318 an RRC reconfiguration complete message to the CU-CP 172A via the DU 174. If the CU-CP 172A receives the DU configuration parameters, the CU-CP 172A includes the DU configuration parameters in the RRC reconfiguration message (e.g., event 316). In some implementations, if the UE 102 and/or base station 104 (e.g., the CU-CP 172A, CU-UP 172B and/or DU 174) support(s) PDU Set-based QoS handling and/or the PDU Session Resource Request message includes PDU Set QOS parameters (e.g., the first set of PDU Set QoS parameters), the CU-CP 172A includes at least one CU configuration parameter for PDU Set-based QoS handling in the RRC reconfiguration message. The UE 102 enables 321 PDU Set-based QoS handling in response to receiving the RRC reconfiguration message, CU configuration parameter(s), and/or the DU configuration parameter(s).

In some implementations, the CU-CP 172A includes one or more DRB configurations in the RRC reconfiguration message (e.g., event 316). The DRB configuration(s) configure one or more DRBs associated with the PDU session and/or QoS flow(s). Depending on the implementation, each of the DRB configuration(s) includes a PDCP configuration and/or a SDAP configuration. In some implementations, the CU-CP 172A includes the CU configuration(s) in the DRB configuration(s), PDCP configuration(s), and/or SDAP configuration(s). In some implementations, the DU configuration parameters include one or more RLC bearer configurations, each configuring an RLC bearer for a particular DRB, and/or include MAC configuration parameters and/or physical layer configuration parameters. In some implementations, the CU-CP 172A determines or configures the PDCP configuration(s) and/or SDAP configuration(s) based on the first set of PDU Set QoS parameters, second set of PDU Set QoS parameters, or third set of PDU Set QoS parameters.

Before or after receiving the UE Context Response message or the RRC reconfiguration complete message and in response to receiving the PDU Session Resource Request message, the CU-CP 172A transmits 320 a PDU Session Resource Response message to the CN 110. In some implementations, if the base station 104 supports PDU Set-based QoS handling as described above, the CU-CP 172A includes, in the PDU Session Resource Response message (e.g., event 320), confirmation information indicating that the base station 104 applies (e.g., performs) PDU Set-based QoS handling based on the first set of PDU Set QoS parameters. In other implementations, if the base station 104 does not support PDU Set-based QoS handling (e.g., based on the first set of PDU Set QoS parameters), the CU-CP 172A includes unsupported information (e.g., a cause or value) in the PDU Session Resource Response message to indicate that the base station 104 does not support PDU Set-based QoS handling or the first set of PDU Set QoS parameters. In some alternative implementations, if the base station 104 supports PDU Set-based QoS handling as described above, the CU-CP 172A implicitly indicates that the base station 104 supports the first set of PDU Set QoS parameters or PDU Set-based QoS handling, such as by excluding the unsupported information in the PDU Session Resource Response message.

In some implementations, the PDU Session Resource Request message and the PDU Session Resource Response message are a PDU Session Resource Setup Request message and a PDU Session Resource Setup Response message, respectively. In other implementations, the PDU Session Resource Request message and the PDU Session Resource Response message are a PDU Session Resource Modify Request message and a PDU Session Resource Modify Response message, respectively.

After receiving the PDU Session Resource Response message, the CN 110 (e.g., the UPF 162) communicates 326 data packets associated with the PDU session or QoS flow(s) with the UE 102 via the base station 104. For example, the CN 110 transmits 326 DL data packets associated with the PDU session or QoS flow(s) to the CU-UP 172B. In some implementations, for each of the DL data packets, the CN 110 generates a CN-to-CU-UP packet including one or more protocol headers and the DL data packet. For example, the CN-to-CU-UP packet is a General Packet Radio System (GPRS) Tunneling Protocol User Plane (GTP-U) packet. The protocol header(s) include an Internet Protocol (IP) header, a User Datagram Protocol (UDP) header, and/or a GTP-U header. In some implementations, the CN 110 performs PDU Set-based QoS handling by grouping the DL data packets into PDU Sets 1, . . . , N and transmits the PDU Sets 1, . . . , N to the CU-UP 172B, where N is a positive integer and larger than one. For each of the DL data packets, the CN 110 generates corresponding PDU Set information and transmits the PDU Set information with the DL data packet to the CU-UP 172B. In some implementations, the PDU Set information includes a PDU Set Sequence Number, a PDU Set size, and/or a PDU Set Importance indicator for a corresponding PDU Set that the corresponding DL data packet belongs to. In some implementations, the PDU Set information includes an End PDU indicator, indicating whether the corresponding DL data packet in the PDU Set is the last data packet in the PDU Set, and/or a PDU Sequence Number for the corresponding DL data packet in the PDU Set. In some implementations, the CN 110 includes the corresponding PDU Set information in a header (e.g., GTP-U header) of each CN-to-CU-UP packet. For example, a PDU Set K of the PDU Sets 1, . . . , N includes M DL data packets K₁, . . . , K_{M}, where K and M are positive integers, 1≤K≤N, and 1≤M. The CN 110 generates PDU Set information K₁, . . . , K_{M} for the DL data packets K₁, . . . , K_{M}, respectively, and generates CN-to-CU-UP packets K₁, . . . , K_{M} including {PDU Set information K₁, the DL data packet K₁}, . . . , {PDU Set information K_{M}, the DL data packet K_{M}}, respectively. The CN 110 transmits the CN-to-CU-UP packets K₁, . . . , K_{M} to the CU-UP 172B. Each of the PDU Set information K₁, . . . , K_{M} includes a PDU Set Sequence Number. In some implementations, each of the PDU Set information K₁, . . . , K_{M} includes a PDU Set Size and/or a PDU Set Importance indicator. Depending on the implementation, the PDU Set Sequence Number, PDU Set Size, and/or PDU Set Importance indicator in the PDU Set information K₁, . . . , K_{M} are the same. In some implementations, the PDU Set information KM includes an End PDU indicator, indicating the DL data packet K_{M} is the last packet in the PDU Set K, and the PDU Set information K₁, . . . , K_{M-1} includes an End PDU indicator, indicating the corresponding DL data packet is not the last data packet in the PDU Set K. In some implementations, the CN-to-CU-UP packets K₁, . . . , K_{M} are GTP-U packets and headers of the GTP-U packets K₁, . . . , K_{M} include the PDU Set information K₁, . . . , K_{M}, respectively. In some implementations, the PDU Set information K₁,. K_{M} include PDU Sequence Numbers K₁, . . . . K_{M}, respectively. The PDU Sequence Numbers K₁, . . . , K_{M} indicate a sequence order of the data packets K₁, . . . , K_{M} in the PDU Set K.

After receiving 326 the DL data packets from the CN 110, the CU-UP 172B transmits 326 the DL data packets to the DU 174. If the CU-UP 172B supports PDU Set-based QoS handling or the third set of PDU Set QoS parameters or enables PDU Set-based QoS handling, the CU-UP 172B ensures that transmission of the DL data packets meets the third set of PDU Set QoS parameters. In cases where the CU-UP 172B receives the CN-to-CU-UP packets from the CN 110, as described above, the CU-UP 172B retrieves the DL data packets from the CN-to-CU-UP packets. For each of the DL data packets, the CU-UP 172B generates a DL PDU (e.g., DL PDCP PDU) including the DL data packet. In some implementations, the CU-UP 172B generates a CU-UP-to-DU packet that includes one or more protocol headers and the DL data packet. For example, the CU-UP-to-DU packet is a GTP-U packet. The protocol header(s) include an IP header, a UDP header, and/or a GTP-U header. If the CU-UP 172B enables PDU Set-based QoS handling, the CU-UP 172B performs PDU Set-based QoS handling by grouping the DL PDUs into PDU Sets 1, . . . , N and transmits the PDU Sets 1, . . . , N to the DU 174. For each of the DL PDUs, the CU-UP 172B generates corresponding PDU Set information and transmits the PDU Set information with the DL PDU to the DU 174, as described above. In some implementations, the CU-UP 172B includes the corresponding PDU Set information in a header (e.g., GTP-U header) of each CU-UP-to-DU packet. For example, the CU-UP 172B receives CN-to-CU-UP packets K₁, . . . , K_{M} from the CN 110 and retrieves the data packets K₁, . . . , K_{M} from the CN-to-CU-UP packets K₁, . . . , K_{M}, respectively. The CU-UP 172B generates DL PDUs K₁, . . . , K_{M} including the data packets K₁, . . . , K_{M}, respectively. The CU-UP 172B generates PDU Set information K₁, . . . , K_{M} for the DL data packets K₁, . . . , K_{M}, respectively, and generates CU-UP-to-DU packets K₁, . . . , K_{M} including {PDU Set information K₁, the DL PDU K₁}, . . . , {PDU Set information K_{M}, the DL PDU K_{M}}, respectively, as described with regard to the CN-to-CU-UP packets above. The CU-UP 172B transmits the CU-UP-to-DU packets K₁, . . . , K_{M} to the DU 174, similar to the CN 110 above. In some implementations, for a CN-to-CU-UP packet and a CU-UP-to-DU packet including the same DL data packet, at least a portion of the PDU Set information in the CN-to-CU-UP packet is the same as at least a portion of the PDU Set information in the CU-UP-to-DU packet. For example, PDU Set Sequence Numbers, PDU Set Importance indicators, and/or indications of the End PDU in the CN-to-CU-UP packet and CU-UP-to-DU packet are the same. In some such cases, the PDU Set sizes and/or PDU Sequence Numbers in the CN-to-CU-UP packet and CU-UP-to-DU packet are the same. Alternatively, the PDU Set sizes and/or PDU Sequence Numbers in the CN-to-CU-UP packet and CU-UP-to-DU packet are different.

If the CU-UP 172B does not support PDU Set-based QoS handling or the third set of PDU Set QoS parameters, or the CU-UP 172B does not enable PDU Set-based QoS handling, the CU-UP 172B ensures that transmission of the DL data packets meets the third set of non-PDU Set QoS parameters or predefined QoS parameters. In some such cases, the CU-UP 172B does not include PDU Set information in the CU-UP-to-DU packets and/or ignores PDU Set information received in the CN-to-CU-UP packets. In some implementations, if the CN 110 determines that the base station 104 (e.g., the CU 172 and/or DU 174) does not support the PDU Set-based QoS handling, the CN 110 refrains from including PDU Set information in a CN-to-CU-UP packet that includes a DL data packet for the UE 102.

After receiving 326 the DL PDUs from the CU-UP 172B, the DU 174 transmits 326 the DL PDUs to the UE 102. If the DU 174 supports PDU Set-based QoS handling or the second set of PDU Set QoS parameters, or the DU 174 enables PDU Set-based QoS handling, the DU 174 ensures that transmission of the DL PDUs meets the second set of PDU Set QoS parameters. If the DU 174 does not support PDU Set-based QoS handling or the second set of PDU Set QoS parameters or does not enable PDU Set-based QoS handling, the CU-UP 172B ensures that transmission of the DL data packets meets the second set of non-PDU Set QoS parameters or predefined QoS parameters. The DU 174 transmits 326 the DL PDUs to the UE 102 via protocol layers (e.g., NR RLC 206B, NR MAC 204B, and NR PHY 202B), based on the configuration parameters 316, and using resources assigned for the UE 102.

After receiving the RRC reconfiguration complete message, the UE 102 transmits 326 UL data packets associated with the PDU session or QoS flow(s) to the DU 174 via protocol layers (e.g., NR PDCP 208, NR RLC 206B, NR MAC 204B, and NR PHY 202B), using the configuration parameters. For example, for each of the UL data packets associated with the PDU session or QoS flow(s), the UE 102 generates a UL PDU (e.g., PDCP PDU or SDAP PDU) including the UL data packet and transmits the UL PDU via protocol layers (e.g., NR RLC 206B, NR MAC 204B, and NR PHY 202B). If the DU 174 supports PDU Set-based QoS handling, supports the second set of PDU Set QoS parameters, or enables PDU Set-based QoS handling, the DU 174 ensures that transmission of the UL data packets from the UE 102 (e.g., to the DU 174 or the CU-UP 172B) meets the second set of PDU Set QoS parameters. In some such cases, the DU 174 schedules the UE 102 to transmit the UL PDUs, based on the second PDU Set QoS parameters. Otherwise, if the DU 174 does not support PDU Set-based QoS handling, does not support the second set of PDU Set QoS parameters, or does not enable or disables PDU Set-based QoS handling, the DU 174 ensures that transmission of the UL PDUs from the UE 102 meets the second set of non-PDU Set QoS parameters or predefined QoS parameters. In some such cases, the DU 174 schedules the UE 102 to transmit the UL data packets based on the second set of non-PDU Set QoS parameters or predefined QoS parameters.

After receiving the UL PDUs from the UE 102 in the event 326, the DU 174 transmits the UL PDUs to the CU-UP 172B. In some implementations, for each of the UL PDUs, the DU 174 generates a DU-to-CU-UP packet including the UL PDU and transmits the DU-to-CU-UP packet to the CU-UP 172B. Depending on the implementation, each of the DU-to-CU-UP packets is a GTP-U packet. In some implementations, the DU 174 does not include PDU Set information in the DU-to-CU-UP packets. When receiving each of the DU-to-CU-UP packets, the CU-UP 172B retrieves a UL PDU from the DU-to-CU-UP packet and retrieves the UL data packet from the UL PDU. The CU-UP 172B transmits the UL data packets to the CN 110 (e.g., the UPF 162). In some implementations, to transmit each of the UL data packets to the CN 110, the CU-UP 172B generates a CU-UP-to-CN packet, including one or more protocol headers and the UL data packet, and transmits the CU-UP-to-CN packet to the CN 110 (e.g., the UPF 162). Depending on the implementation, each of the CU-UP-to-CN packets is a GTP-U packet. The protocol header(s) include an IP header, a UDP header, and/or a GTP-U header. In some implementations, if the CU-UP 172B enables PDU Set-based QoS handling for the PDU session or QoS flow(s) and/or configures the UE 102 to enable PDU Set-based QoS handling for the PDU session or QoS flow(s), the CU-UP 172B performs PDU Set-based QoS handling by grouping the UL data packets into PDU Sets 1, . . . , P and transmits the PDU Sets 1, . . . , P to the CN 110. For each of the UL data packets included in the CU-UP-to-CN packets, the CU-UP 172B includes corresponding PDU Set information in the corresponding CU-UP-to-CN packet. In other implementations, the CU-UP 172B does not include PDU Set information in the CU-UP-to-CN packets.

In some implementations, the UE 102 performs PDU Set-based QoS handling to transmit the UL data packets. In some implementations, the UE 102 performs PDU Set-based QoS handling by grouping the UL data packets or UL PDUs into PDU Sets 1, . . . , P and transmits the PDU Sets 1 . . . , P to the DU 174, where L is a positive integer and larger than one. In further implementations, to perform the PDU Set-based QoS handling, the UE 102 includes, in (e.g., a header of) each of the UL PDUs, UL PDU Set information for the respective UL PDU or UL data packet. In some implementations, the UL PDU Set information for the respective UL PDU or UL data packet includes an End PDU indicator to indicate whether the UL data packet included in the respective UL PDU is the last data packet in a PDU Set to which the UL data packet belongs. In some implementations, the UL PDU Set information additionally includes a PDU Set Sequence Number, a PDU Set size, and/or a PDU Set Importance indication for a UL PDU Set to which the respective UL PDU or UL data packet belongs. In other implementations, the UL PDU Set information does not include a PDU Set Sequence Number, a PDU Set size, and/or a PDU Set Importance indication. In some implementations, the UL PDU Set information includes a PDU Sequence Number for the corresponding UL data packet within a PDU Set to which the UL data packet belongs. In other implementations, the UL PDU Set information does not include a PDU Sequence Number for the corresponding UL data packet within a PDU Set to which the UL data packet belongs. In some implementations, the UL PDUs are SDAP PDUs. The UE includes the UL PDU Set information for each of the UL data packets in a header of the respective SDAP PDU. In some implementations, the UE 102 includes, in the SDAP PDU, a QoS flow identifier indicating the QoS flow with which the UP data packet included in the UL PDU is associated. For each of the SDAP PDUs, the UE 102 generates a UL PDCP PDU including the SDAP PDU and transmits the UL PDCP PDUs to the DU 174 via protocol layers (e.g., NR RLC 206B, NR MAC 204B, and NR PHY 202B). The UE 102 includes a PDCP sequence number in each of the UL PDCP PDUs, which is different from the PDU Sequence Number in the SDAP PDUs. In other implementations, the UL PDUs are PDCP PDUs. The UE 102 includes the UL PDU Set information for each of the UL data packets in a header of the respective PDCP PDU. The UE 102 transmits the PDCP PDUs to the DU 174 via protocol layers (e.g., NR RLC 206B, NR MAC 204B, and NR PHY 202B).

In some implementations, a PDU Set L of the PDU Sets 1, . . . , P includes X UL PDUs L₁, . . . , L_{X}, where L and X are positive integers, 1≤L≤P, and 1≤X. The UE 102 includes UL data packets L₁, . . . , L_{X} in the UL PDUs L₁, . . . , L_{X}, respectively. In the End PDU indicator in the header of the UL PDU L_{X}, the UE 102 indicates that the UL data packet L_{X} is the last data packet in the PDU Set L. In the End PDU indicator in the header of each of the UL PDUs L₁, . . . , L_{X-1}, the UE 102 indicates that the corresponding UL data packet is not the last data packet in the PDU Set L. Alternatively, the UE 102 excludes, in each of the UL PDUs L₁, . . . , L_{X-1}, the End PDU indicator indicating that the corresponding UL data packet is the last data packet in the PDU Set L. In some implementations, the UE 102 includes, in the header of each of the UL PDUs L₁, . . . , L_{X-1}, a PDU Set Sequence Number, a PDU Set size, and/or a PDU Set Importance indicator for the PDU Set L. The PDU Set Sequence Number is L or L-1. In other implementations, the UE 102 does not include a PDU Set Sequence Number, a PDU Set size, and/or a PDU Set Importance indicator in the UL PDUs L₁, . . . , L_{X-1}. In some implementations, the UE 102 includes PDU Sequence Numbers (e.g., 0, . . . , X-1 or 1, . . . , X) in the header of the UL PDUs L₁, . . . , L_{X-1}, respectively. In other implementations, the UE 102 does not include PDU Sequence Numbers in the header of the UL PDUs L₁, . . . , L_{X-1}.

In some implementations, when the CU-UP 172B receives a UL PDU including UL PDU Set information and a UL data packet from the UE 102 via the DU 174 as described above, the CU-UP 172B retrieves the UL data packet from the UL PDU and generates a CU-UP-to-CN packet, including the UL data packet. Depending on the implementation, the CU-UP-to-CN packet is a GTP-U packet. In some implementations, the CU-UP 172B includes the first UL PDU Set information in a header of the CU-UP-to-CN packet. In other implementations, the CU-UP 172B generates second UL PDU Set information based on the first UL PDU Set information and/or other non-PDU Set information, and the CU-UP 172B includes the second UL PDU Set information in the header of the CU-UP-to-CN packet. For example, the other information includes a sequence number in a header of the UL PDU. If the UL PDU is a PDCP PDU, the sequence number is a PDCP sequence number. In one implementation, the second UL PDU Set information includes a portion of the first UL PDU Set information. For example, the first UL PDU Set information includes an End PDU indicator indicating whether the UL data packet is the last data packet in a PDU Set, and the CU-UP 172B includes the indication of End PDU in the second UL PDU Set information (e.g., in the header of the CU-UP-to-packet). In another example, the first UL PDU Set information includes a PDU Set size for the PDU Set, and the CU-UP 172B includes the PDU Set size in the second UL PDU Set information (e.g., in the header of the CU-UP-to-packet).

In some cases where the UL PDU or the first UL PDU Set information does not include a PDU Set Sequence Number, the CU-UP 172B generates a PDU Set Sequence Number for the PDU Set and includes the PDU Set Sequence Number in the second UL PDU Set information. In further cases where the UL PDU or the first UL PDU Set information does not include a PDU Sequence Number for the UL PDU, the CU-UP 172B generates a PDU Sequence Number for the UL data packet based on the sequence number (e.g., PDCP sequence number) in the header of the UL PDU and includes the PDU Sequence Number in the second UL PDU Set information. In some cases where the first PDU Set information does not include a PDU Set Importance indicator, the CU-UP 172B sets a PDU Set Importance indicator to a predetermined value and includes the PDU Set Importance indicator in the second PDU Set information. In other implementations, the CU-UP 172B sets the PDU Set Importance indicator to a value, based on the first set of PDU Set QoS parameters, and includes the PDU Set Importance indicator in the second PDU Set information. In some implementations, if the first PDU Set information does not include a PDU Set size, the CU-UP 172B does not include a PDU Set size in the second PDU Set information. Alternatively, the CU-UP 172B sets a PDU Set size to a predetermined value and includes the PDT Set size in the second PDU Set information.

In further implementations, the UE 102 groups UL data packets into the UL PDU Set 1 and UL PDU Set 2. The UL PDU Set 1 incudes Y UL PDUs 1₁, . . . , 1_{Y} including UL data packets 1₁, . . . , 1_{Y}, respectively. Y is a positive integer and 1≤Y. The UL PDU Set 2 incudes ZUL PDUs 2₁, . . . . , 2_{Z} including UL data packets 2₁, . . . . , 2_{Z}, respectively. Z is a positive integer and 1≤Z. In some implementations, the UE 102 assigns sequence numbers (e.g., PDCP sequence numbers) 1₁, . . . , 1_{Y}, and 2₁, . . . . , 2_{Z} for the UL PDUs or UL data packets 1₁, . . . , 1_{Y}, and 2₁, . . . . , 2_{Z} in ascending order, respectively. The UE 102 includes sequence numbers 1₁, . . . , 1_{Y}, and 2₁, . . . . , 2_{Z} in the UL PDUs 1₁, . . . , 1_{Y}, and 2₁, . . . . , 2_{Z}, respectively. The UE 102 transmits the Y UL PDUs and Z UL PDUs to the CU-UP 172B via the DU 174. In some implementations, the UE 102 does not include a PDU Set Sequence Number in the UL PDUs 1₁, . . . , 1_{Y}, and 2₁, . . . . , 2_{Z}. The UE 102 includes an End PDU indicator in a header of the UL PDU 1_{Y} to indicate that the UL data packet in the UL PDU 1_{Y} is the last data packet of the PDU Set 1. In each of the UL PDUs 1₁, . . . , 1_{Y-1}, the UE 102 includes an End PDU indicator to indicate that the included UL data packet is not the last data packet of the PDU Set 1.

Alternatively, in each of the UL PDUs 1₁, . . . , 1_{Y-1}, the UE 102 excludes the End PDU indicator indicating that the included UL data packet is the last data packet. The UE 102 includes an End PDU indicator in a header of the UL PDU 2_{Z} to indicate that the UL data packet in the UL PDU 2_{Z} is the last data packet of the PDU Set 2. In each of the UL PDUs 2₁, . . . . , 2_{Z-1}, the UE 102 includes an End PDU indicator to indicate that the included UL data packet is not the last data packet of the PDU Set 2. Alternatively, in each of the UL PDUs 2₁, . . . . , 2_{Z-1}, the UE 102 excludes the End PDU indicator indicating that the included UL data packet is the last data packet.

When the CU-UP 172B receives the UL PDUs 1₁, . . . , 1_{Y}, the CU-UP 172B determines the UL PDUs belong to a first PDU Set and determines a PDU Set Number 1 (e.g., value 0) for the first PDU Set. The CU-UP 172B retrieves the UL data packets 1₁, . . . , 1_{Y} from the UL PDUs 1₁, . . . , 1_{Y}, respectively. The CU-UP 172B generates CU-UP-to-CN packets 1₁, . . . , 1_{Y} including the UL PDUs 1₁, . . . , 1_{Y} and includes the PDU Set Number 1 in the header of the CU-UP-to-CN packets 1₁, . . . , 1_{Y}, respectively. The CU-UP 172B transmits the CU-UP-to-CN packets 1₁, . . . , 1_{Y} to the CN 110 (e.g., UPF 162). In some implementations, when the CU-UP 172B receives the UL PDU 1_{Y}, and a header of the UL PDU includes an End PDU indicator indicating that the included UL data packet is the last data packet, the CU-UP 172B determines that UL PDU(s) with a sequence number before a sequence number of the UL PDU 1_{Y} belong to the first PDU Set. Before or after receiving the UL PDU 1_{Y}, the CU-UP 172B receives the UL PDUs 2₁, . . . . , 2_{Z} and retrieves the UL data packets 2₁, . . . . , 2_{Z} from the UL PDUs 2₁, . . . . , 2_{Z}. After receiving the UL PDU 1_{Y}, the CU-UP 172B determines the UL PDUs or UL data packets 2₁, . . . . , 2_{Z} belong to a different PDU Set (e.g., a second PDU Set) and determines a PDU Set Number 2 (e.g., value 2) for the second PDU Set. The CU-UP 172B generates CU-UP-to-CN packets 2₁, . . . . , 2_{Z} including the UL PDUs 2₁, . . . . , 2_{Z} and includes the PDU Set Number 2 in the header of the CU-UP-to-CN packets 2₁, . . . . , 2_{Z}, respectively. The CU-UP 172B transmits the CU-UP-to-CN packets 2₁, . . . . , 2_{Z} to the CN 110.

In some implementations, the CU-UP 172B determines whether to discard a PDU Set received from the CN 110 or UE 102 based on a PDU Set Importance indication for the PDU Set. For example, in cases where the CU-UP 172B is congested or has no sufficient resources, if the PDU Set Importance indication is set to a first value, the CU-UP 172B discards the PDU Set (e.g., because the CU-UP 172B does not conform the transmission of the PDU Set to the third set of PDU Set QoS parameters). Otherwise, if the PDU Set Importance indication is set to a second value, the CU-UP 172B refrains from discarding the PDU Set.

In some implementations, the UE 102 does not perform PDU Set-based QoS handling to transmit the UL data packets. In such cases, the UE 102 does not include or refrains from including PDU Set information in the UL PDUs.

In some implementations, the CN 110 enables 325 PDU Set-based QoS handling for the PDU session or QoS flow(s) after (e.g., in response to) receiving the PDU Session Resource Response message. In other implementations, the CN 110 enables 325 PDU Set-based QoS handling for the PDU session or QoS flow(s), regardless of when the CN 110 receives the PDU Session Resource Response message. In some implementations, the CU-UP 172B enables 324 PDU Set-based QoS handling for the PDU session or QoS flow(s) in response to receiving 312 the PDU Session Resource Request message or the first set of PDU Set QoS parameters. In some implementations, if the CU 172 receives a PDU Session Resource Release Command message for the PDU session from the CN 110, the CU 172 disables PDU Set-based QoS handling for the PDU session or QoS flow. In some implementations, if the CU 172 receives a PDU Session Resource Modify Request message releasing the QoS flow from the CN 110, the CU 172 disables PDU Set-based QoS handling for the QoS flow. In some implementations, if the CU 172 receives a PDU Session Resource Request message (e.g., a PDU Session Resource Setup Request message or a PDU Session Resource Modify Request message) from the CN 110, excluding PDU Set QoS parameters, for a PDU session or a QoS flow for a UE (e.g., the UE 102 or another UE), the CU 172 disables or refrains from enabling PDU Set-based QoS handling for the PDU session or QoS flow. In some implementations, the CU-CP 172A includes, in the Bearer Context Request message (e.g., event 315), a configuration parameter enabling or configuring PDU Set-based QoS handling for the UE 102, PDU session, and/or QoS flow(s). In some implementations, the CU-UP 172B enables 324 PDU Set-based QoS handling for the PDU session or QOS flow in response to receiving the Bearer Context Request message, the third set of PDU Set QoS parameters, or the configuration parameter enabling or configuring PDU Set-based QoS handling. In some implementations, if the CU-UP 172B receives a Bearer Context Release Command message or a Bearer Context Modification Request message to release a bearer context for the PDU session or QoS flow from the CU-CP 172A, the CU-UP 172B disables or refrains from enabling PDU Set-based QoS handling for the PDU session or QoS flow. In some implementations, if the CU-UP 172B receives a Bearer Context Request message (e.g., a Bearer Context Setup Request message or a Bearer Context Modification Request message) from the CN 110 excluding PDU Set QoS parameters for a PDU session or a QoS flow for a UE (e.g., the UE 102 or another UE), the CU-UP 172B 172 disables or refrains from enabling PDU Set-based QoS handling for the PDU session or QoS flow.

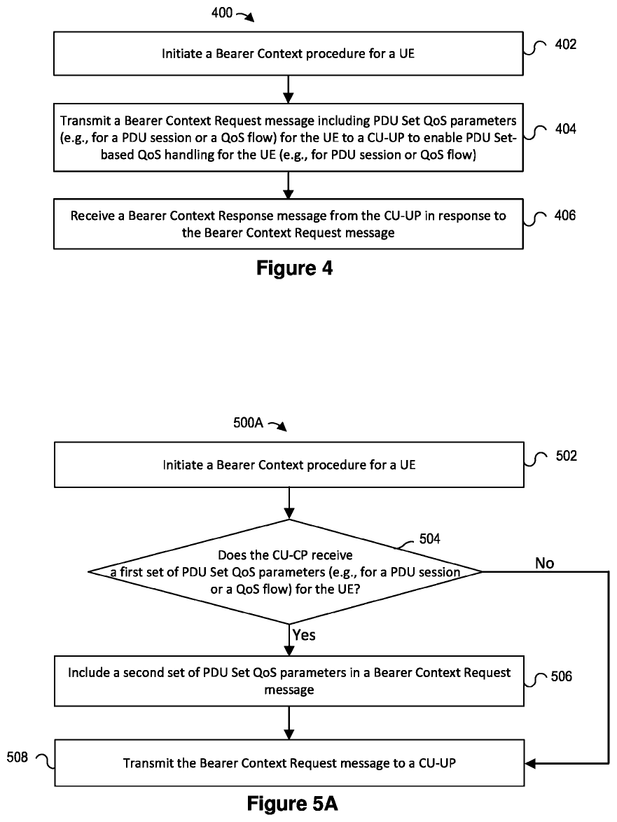

FIG. 4 is a flow diagram of an example method 400 for transmitting PDU Set QoS parameters to a CU-UP (e.g., the CU-UP 172B of the base station 104) to enable PDU Set-based QoS handling for a UE (e.g., the UE 102), implemented by a CU-CP (e.g., the CU-CP 172A of the base station 104).

The method 400A begins at block 402, where the CU-CP initiates a Bearer Context procedure for a UE (e.g., events 315, 317). At block 404, the CU-CP transmits a Bearer Context Request message including PDU Set QoS parameters (e.g., for a first PDU session or a first QoS flow) for the UE to a CU-UP to enable or request to enable PDU Set-based QoS handling for the UE (e.g., for the first PDU session or first QoS flow) (e.g., event 315). At block 406, the CU-CP receives a Bearer Context Response message from the CU-UP in response to the Bearer Context Request message (e.g., event 317).

In some implementations, the CU-CP initiates a second Bearer Context procedure for a second UE (e.g., events 315, 317). In response to the initiation, the CU-CP transmits a second Bearer Context Request message excluding PDU Set QoS parameters (e.g., for a second PDU session or a second QoS flow) for the second UE to a second CU-UP (e.g., event 315). The CU-CP receives a second Bearer Context Response message from the second CU-UP in response to the second Bearer Context Request message (e.g., event 317).

In some implementations, the first UE and second UE are the same UE. In other implementations, the first UE and second UE are different UEs. Further, depending on the implementation, the first CU-UP and second CU-UP are different CU-UPs or the same CU-UP. In some implementations, the first Bearer Context Request message and second Bearer Context Request message are the same Bearer Context Request message, and the first Bearer Context Response message and second Bearer Context Response message are the same Bearer Context Response message. In other implementations, the first Bearer Context Request message and second Bearer Context Request message are different Bearer Context Request messages, and the first Bearer Context Response message and second Bearer Context Response message are different Bearer Context Response messages.

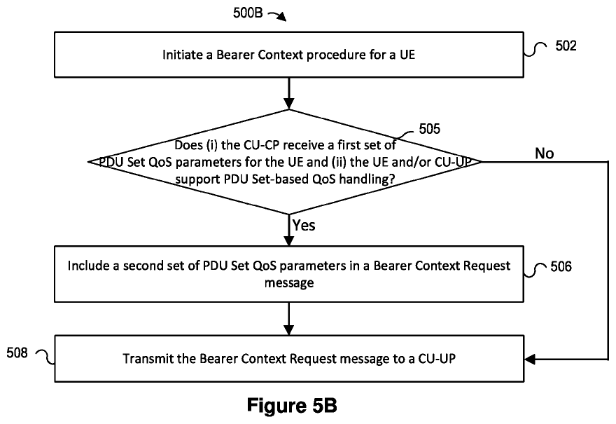

FIG. 5A is a flow diagram of an example method 500A for transmitting PDU Set QoS parameters to a CU-UP (e.g., the CU-UP 172B of the base station 104) to enable PDU Set-based QoS handling for a UE (e.g., the UE 102), implemented by a CU-CP (e.g., the CU-CP 172A of the base station 104).

The method 500A begins at block 502, where the CU-CP initiates a Bearer Context procedure for a UE (e.g., events 315, 317). At block 504, the CU-CP determines whether the CU-CP receives a first set of PDU Set QoS parameters (e.g., for a PDU session or a QoS flow) for the UE. If the CU-CP determines that the CU-UP receives a first set of PDU Set QoS parameters (e.g., for a PDU session or a QoS flow) for the UE at block 504, the flow proceeds to block 506. In some implementations, the CU-CP receives a CN-to-BS message (e.g., a PDU Session Resource Request message) including the first set of PDU Set QoS parameters from a CN (e.g., AMF 164 or SMF 166 of CN 110) (e.g., event 312). In some implementations, the CU-UP transmits a BS-to-CN message (e.g., a PDU Session Resource Response message) to the CN in response to the CN-to-BS message. At block 506, the CU-CP includes a second set of PDU Set QoS parameters in a Bearer Context Request message (e.g., event 315). In some implementations, the second set of PDU Set QoS parameters is the same as the first set of PDU Set QoS parameters. In other implementations, the CU-CP determines the second set of PDU Set QoS parameters based on the first set of PDU Set QoS parameters. In further implementations, the second set of PDU Set QoS parameters is the third set of PDU Set QoS parameters described for FIG. 3. Examples and implementations described for the third set of PDU Set QoS parameters for FIG. 3 therefore apply to the second set of PDU Set QoS parameters.

Otherwise, if the CU-CP does not determine that the CU-CP receives a first set of PDU Set QoS parameters (e.g., for a PDU session or a QoS flow) for the UE at block 504, the flow proceeds to block 508. In other words, the CU-CP refrains from including PDU Set QoS parameters in the Bearer Context Request message. At block 508, the CU-CP transmits the Bearer Context Request message to a CU-UP (e.g., event 317).

In some implementations, the Bearer Context Response message indicates whether the CU-UP applies the second set of PDU Set QoS parameters or PDU Set-based QoS handling for the UE. In some implementations, if the CU-CP determines that the Bearer Context Response message indicates that the CU-UP applies the second set of PDU Set QoS parameters or PDU Set-based QoS handling for the UE, the CU-CP includes, in the BS-to-CN message, information indicating that the first set of PDU Set QoS parameters or PDU Set-based QoS handling is applied. Alternatively, if the CU-CP determines that the Bearer Context Response message indicates that the CU-UP applies the second set of PDU Set QoS parameters or PDU Set-based QoS handling for the UE, the CU-CP excludes, in the BS-to-CN message, information indicating that the first set of PDU Set QoS parameters or PDU Set-based QoS handling is not applied.

Otherwise, depending on the implementation, if the CU-UP determines that the Bearer Context Response message indicates that the CU-UP does not apply the second set of PDU Set QoS parameters or PDU Set-based QoS handling for the UE, the CU-CP includes, in the BS-to-CN message, information indicating that the first set of PDU Set QoS parameters or PDU Set-based QoS handling is not applied. In some implementations, the information indicating that the first set of PDU Set QoS parameters or PDU Set-based QoS handling is not applied is a cause indicating that the second set of PDU Set QoS parameters or PDU Set-based QoS handling is not applied. In some implementations, the Bearer Context Request message includes a cause to indicate that the second set of PDU Set QoS parameters or PDU Set-based QoS handling is not applied, and the Bearer Context Request message excludes the cause to indicate that the second set of PDU Set QoS parameters or PDU Set-based QoS handling is applied. In some implementations, the CN-to-BS message and BS-to-CN message are NG Application Protocol (NGAP) messages. In other implementations, the CN-to-BS message and BS-to-CN message are 5G network interface messages, 6G network interface messages, etc.

FIG. 5B is a flow diagram of an example method 500B similar to the method 500A, except that the method 500B includes block 505 instead block 504. As such, the CU-CP makes the determination based additionally on whether the UE and/or CU-UP support PDU Set-based QoS handling. In particular, at block 505, the CU-CP determines whether the CU-CP receives a first set of PDU Set QoS parameters (e.g., for a PDU session or a QoS flow) for the UE and whether the UE and/or CU-UP support(s) PDU Set-based QoS handling. If the CU-CP determines that the CU-CP receives a first set of PDU Set QoS parameters (e.g., for a PDU session or a QoS flow) for the UE (e.g., event 312) and the UE and/or CU-UP support(s) PDU Set-based QoS handling at block 505, the flow proceeds to block 506. Otherwise, if the CU-CP determines that the CU-CP does not receive a first set of PDU Set QoS parameters (e.g., for a PDU session or a QoS flow) for the UE and/or the UE or CU-UP does not support PDU Set-based QoS handling at block 505, the flow proceeds to block 508.

In some implementations, the CU-UP receives, from the UE, UE capabilities of the UE indicating whether the UE supports PDU Set-based QoS handling (e.g., event 310). For example, the CU-UP receives a UE information message that includes a UE-NR-Capability IE including the UE capabilities from the UE. In other implementations, the CU-UP receives a CN-to-BS message including the UE capabilities from the CN (e.g., AMF 164).

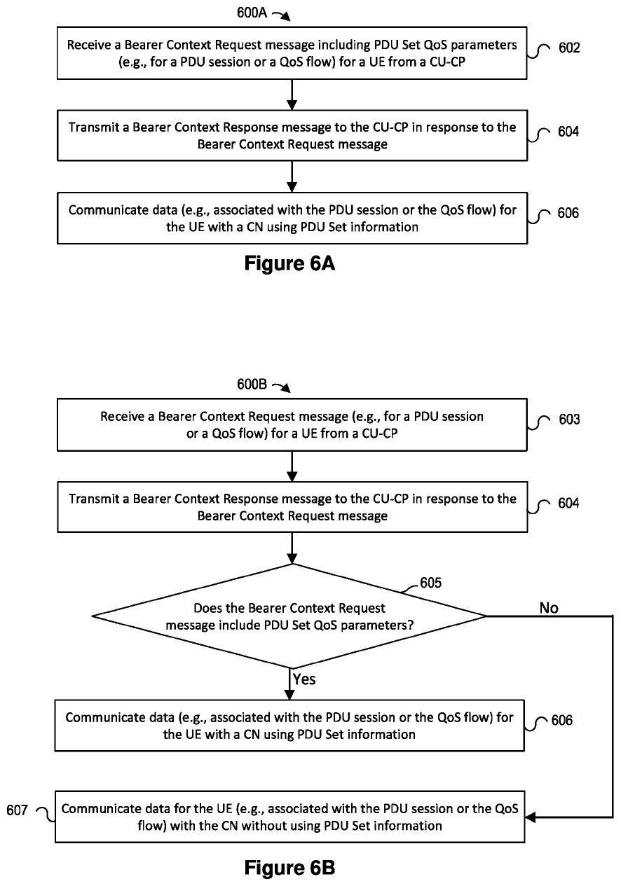

FIG. 6A is a flow diagram of an example method 600A for performing PDU Set-based QoS handling on data received from a CN (e.g., the CN 110 or UPF 162) or from a UE (e.g., the UE 102), implemented by a CU-UP (e.g., the CU-UP 172B of the base station 104).

The method 600A begins at block 602, where the CU-UP receives a Bearer Context Request message including PDU Set QoS parameters (e.g., for a first PDU session or a first QoS flow) for a UE from a CU-CP (e.g., event 315). At block 604, the CU-UP transmits a Bearer Context Response message to the CU-CP in response to the Bearer Context Request message (e.g., event 317). At block 606, the CU-UP communicates data (e.g., associated with the first PDU session or the first QoS flow) for the UE with a CN (e.g., UPF 162) using PDU Set information (e.g., event 326).

In some implementations, the CU-UP receives a second Bearer Context Request message excluding PDU Set QoS parameters (e.g., for a second PDU session or a second QoS flow) for a second UE from the CU-CP (e.g., event 315). The CU-UP transmits a second Bearer Context Response message to the CU-CP in response to the second Bearer Context Request message (e.g., event 317). The CU-UP communicates data (e.g., associated with the second PDU session or the second QoS flow) for the second UE with the CN without using PDU Set information (e.g., event 326).

In some implementations, the first UE and second UE are the same UE or different UEs. In further implementations, the first Bearer Context Request message and second Bearer Context Request message are the same Bearer Context Request message, and the first Bearer Context Response message and second Bearer Context Response message are the same Bearer Context Response message. In other implementations, the first Bearer Context Request message and second Bearer Context Request message are different Bearer Context Request messages, and the first Bearer Context Response message and second Bearer Context Response message are different Bearer Context Response messages.

FIG. 6B is a flow diagram of an example method 600B similar to the method 600A, except that the method 600B includes blocks 603, 605 and 607 instead of block 602. As such, the CU-UP determines whether to use the PDU information to communicate data based on whether the message from the CU-CP includes the parameters. In particular, at block 603, the CU-UP receives a Bearer Context Request message (e.g., for a PDU session or a QoS flow) for the UE. At block 605, the CU-UP determines whether the Bearer Context Request message includes PDU Set QoS parameters (e.g., for the PDU session or the QoS flow) for the UE. If the CU-UP determines that the UE Context Request message includes PDU Set QoS parameters (e.g., for the PDU session or the QoS flow) for the UE at block 605, the flow proceeds to block 606. Otherwise, if the CU-UP determines that the Bearer Context Request message does not include PDU Set QoS parameters (e.g., for the PDU session or the QoS flow) for the UE at block 605, the flow proceeds to block 607. At block 607, the CU-UP communicates data (e.g., associated with the PDU session or the QoS flow) for the UE with the CN without using PDU Set information (e.g., event 326).

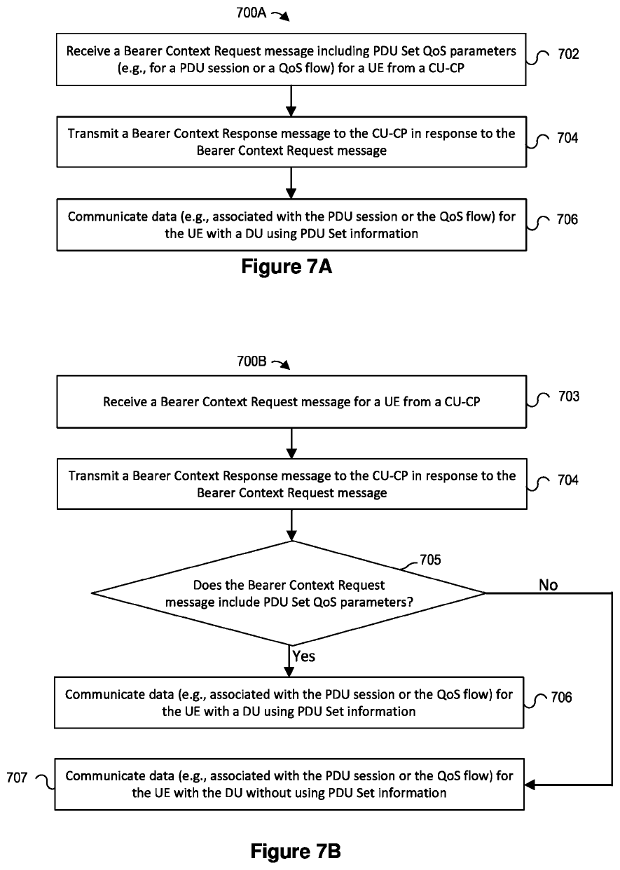

FIG. 7A is a flow diagram of an example method 700A for performing PDU Set-based QoS handling on data received from a CN (e.g., the CN 110 or UPF 162) or from a UE (e.g., the UE 102), implemented by a CU-UP (e.g., the CU-UP 172B of the base station 104) communicating with a DU (e.g., DU 174).

The method 700A begins at block 702, where the CU-UP receives a Bearer Context Request message including PDU Set QoS parameters (e.g., for a first PDU session or a first QoS flow) for a UE from a CU-CP (e.g., event 315). At block 704, the CU-UP transmits a Bearer Context Response message to the CU-CP in response to the Bearer Context Request message (e.g., event 317). At block 706, the CU-UP communicates data (e.g., associated with the first PDU session or the first QoS flow) for the UE with a DU using PDU Set information (e.g., event 326). In some implementations, the CU-UP communicates the data (e.g., associated with the second PDU session or the second QoS flow) for the second UE with the CN using PDU Set information (e.g., event 326).

In some implementations, the CU-UP receives a second Bearer Context Request message excluding PDU Set QoS parameters (e.g., for a second PDU session or a second QoS flow) for a second UE from the CU-CP (e.g., event 315). The CU-UP transmits a second Bearer Context Response message to the CU-CP in response to the second Bearer Context Request message (e.g., event 317). The CU-UP communicates data (e.g., associated with the second PDU session or the second QoS flow) for the second UE with the DU without using PDU Set information (e.g., event 326). In some implementations, the CU-UP communicates the data (e.g., associated with the second PDU session or the second QoS flow) for the second UE with the CN without using PDU Set information (e.g., event 326).

Depending on the implementation, examples and implementations described for FIG. 6A apply to FIG. 7A as applicable.

FIG. 7B is a flow diagram of an example method 700B similar to the method 700A, except that the method 700B includes blocks 703, 705, and 707 instead of block 702. At block 703, the CU-UP receives a Bearer Context Request message for a UE from a CU-CP. At block 705, the CU-UP determines whether the Bearer Context Request message includes PDU Set QoS parameters. If the CU-UP determines that the Bearer Context Request message includes PDU Set QoS parameters at block 705, the flow proceeds to block 706. In some implementations, the CU-UP communicates the data (e.g., associated with the second PDU session or the second QoS flow) for the second UE with the CN using PDU Set information (e.g., event 326).

Otherwise, if the CU-UP determines that the Bearer Context Request message does not include PDU Set QoS parameters at block 705, the flow proceeds to block 707. At block 707, the CU-UP communicates data (e.g., associated with the PDU session or the QoS flow) for the UE with the DU without using PDU Set information. In some implementations, the CU-UP communicates the data (e.g., associated with the second PDU session or the second QoS flow) for the second UE with the CN without using PDU Set information (e.g., event 326).

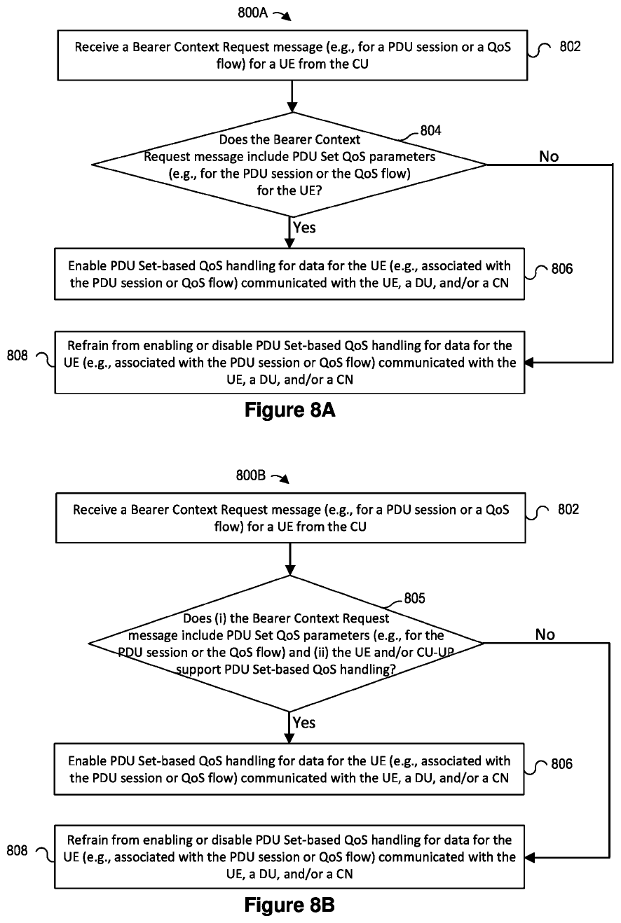

FIG. 8A is a flow diagram of an example method 800A for performing PDU Set-based QoS handling on data received from a CN (e.g., the CN 110 or UPF 162) or from a UE (e.g., the UE 102), implemented by a CU-UP (e.g., the CU-UP 172B of the base station 104) communicating with a DU (e.g., DU 174).

The method 800A begins at block 802, where the CU-UP receives a Bearer Context Request message (e.g., for a PDU session or a QoS flow) for a UE from the CU (e.g., event 315). At block 804, the CU-UP determines whether the Bearer Context Request message includes PDU Set QoS parameters (e.g., for the PDU session or the QoS flow) for the UE. If the CU-UP determines that the Bearer Context Request message includes PDU Set QoS parameters (e.g., for the PDU session or the QoS flow) for the UE at block 804, the flow proceeds to block 806. At block 806, the CU-UP enables PDU Set-based QoS handling for data for the UE (e.g., associated with the PDU session or QoS flow) communicated with the UE, a DU, and/or a CN (e.g., UPF 162) (e.g., event 324). Otherwise, if the CU-UP determines that the Bearer Context Request message does not include PDU Set QoS parameters (e.g., for the PDU session or the QoS flow) for the UE at block 804, the flow proceeds to block 808. At block 808, the CU-UP refrains from enabling or disables PDU Set-based QoS handling for data for the UE (e.g., associated with the PDU session or QoS flow) communicated with the UE, a DU, and/or a CN (e.g., UPF 162).

FIG. 8B is a flow diagram of an example method 800B similar to the method 800A, except that the method 800B includes block 805 instead of block 804. As such, the CU-UP makes the determination based additionally on whether the UE and/or CU-UP support PDU Set-based QoS handling. In particular, at block 805, the CU-UP determines whether the Bearer Context Request message includes PDU Set QoS parameters (e.g., for the PDU session or the QoS flow) and whether the UE and/or CU-UP support(s) PDU Set-based QoS handling. If the CU-CP determines that the Bearer Context Request message includes PDU Set QoS parameters (e.g., for the PDU session or the QoS flow) and the UE and/or CU-UP support(s) PDU Set-based QOS handling at block 805, the flow proceeds to block 806. Otherwise, if the CU-CP determines that the Bearer Context Request message does not include PDU Set QoS parameters (e.g., for the PDU session or the QoS flow) or the UE and/or CU-UP does not support PDU Set-based QoS handling at block 805, the flow proceeds to block 808.

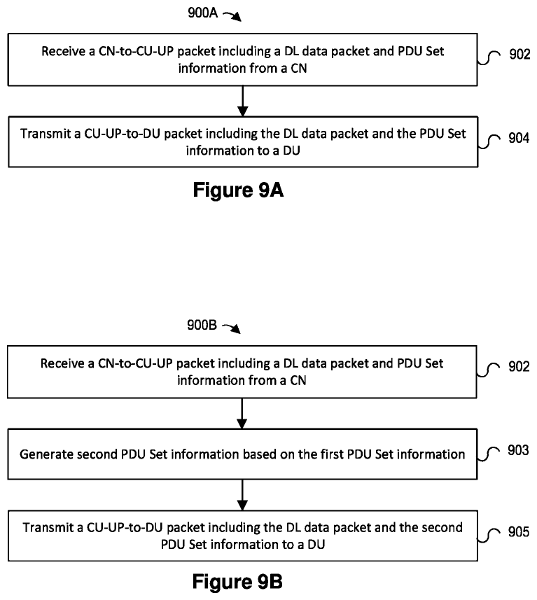

FIG. 9A is a flow diagram of an example method 900A for performing PDU Set-based QoS handling, implemented by a CU-UP (e.g., the CU-UP 172B of the base station 104) communicating with a DU (e.g., DU 174) and/or CN (e.g., CN 110).

The method 900A begins at block 902, where the CU-UP receives a CN-to-CU-UP packet including a DL data packet and PDU Set information from a CN (e.g., event 326). At block 904, the CU-UP transmits a CU-UP-to-DU packet including the DL data packet and the PDU Set information to a DU (e.g., event 326).

In some implementations, the PDU Set information includes information for a PDU Set to which the DL data packet belongs. For example, the information includes a PDU Set Sequence Number, a PDU Set size, and/or a PDU Set Importance indicator for the PDU Set. In some implementations, the PDU Set information further includes a PDU Sequence Number for the DL data packet in the PDU Set, and/or includes an End PDU indicator that indicates whether the DL data packet in a PDU Set is the last data packet in the PDU Set.

In some implementations, the CN-to-CU-UP packet is a GTP-U packet. In further implementations, the CU-UP-to-DU packet is a GTP-U packet. In some implementations, the CN-to-CU-UP packet includes a first source IP address and a first destination IP address, and the CU-UP-to-DU packet includes a second source IP address and a second destination IP address.

In some implementations, the CU-UP generates a DL PDU including the DL data packet and includes the DL PDU in the CU-UP-to-DU packet. In one implementation, the CU-UP encrypts the DL data packet to an encrypted packet and includes the encrypted packet in the DL PDU. In some implementations, the CU-UP refrains from including the PDU Set information in the DL PDU. In other implementations, the CU-UP generates a first DL PDU including the DL data packet, generates a second DL PDU including the first DL PDU, and includes the second DL PDU in the CU-UP-to-DU packet. In one implementation, the CU-UP encrypts the DL data packet to an encrypted packet and includes the encrypted packet in the first DL PDU. In another implementation, the CU-UP encrypts the first DL PDU to an encrypted packet and includes the encrypted packet in the second DL PDU. In some implementations, the CU-UP refrains from including the first PDU Set information in the first DL PDU and second DL PDU.

FIG. 9B is a flow diagram of an example method 900B similar to the method 900A, except that the method 900B includes blocks 903 and 905 instead of block 904. As such, the CU-UP generates and transmits second PDU Set information. In particular, at block 903, the CU-UP generates second PDU Set information based on the first PDU Set information (e.g., event 326). At block 905, the CU-UP transmits a CU-UP-to-DU packet including the DL data packet and the second PDU Set information to a DU (e.g., event 326).

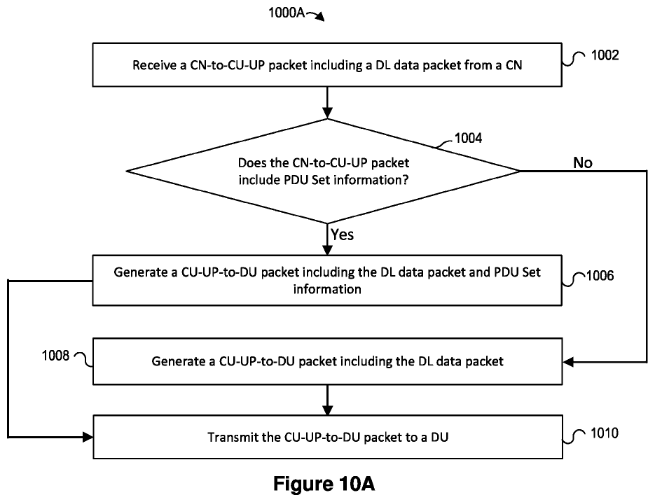

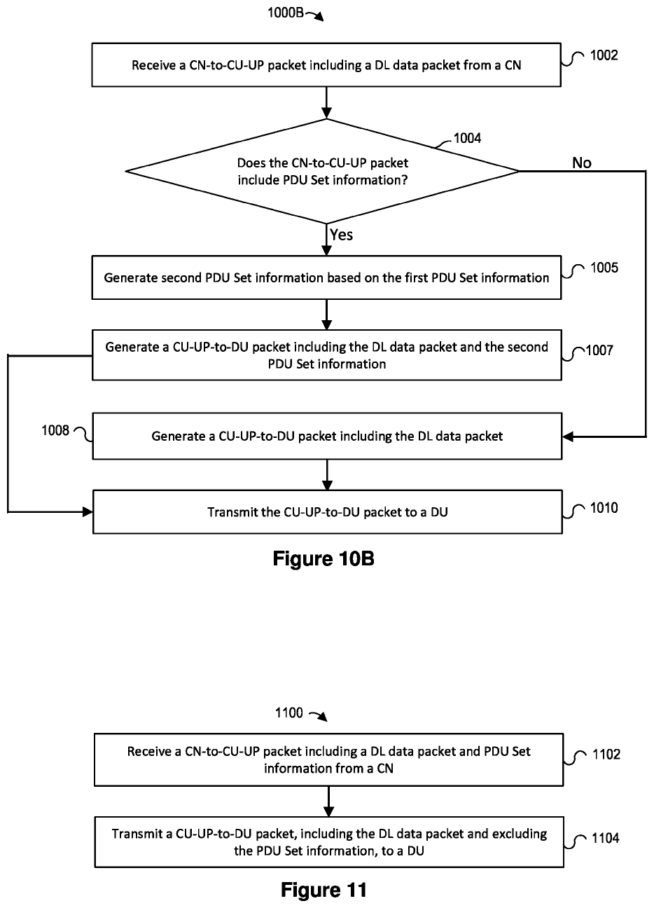

FIG. 10A is a flow diagram of an example method 1000A for performing PDU Set-based QoS handling, implemented by a CU-UP (e.g., the CU-UP 172B of the base station 104) communicating with a DU (e.g., DU 174) and/or CN (e.g., CN 110).

The method 1000A begins at block 1002, where the CU-UP receives a CN-to-CU-UP packet including a DL data packet from a CN (e.g., event 1002) (e.g., event 326). At block 1004, the CU-UP determines whether the CN-to-CU-UP packet includes PDU Set information. If the CU-UP determines that the CN-to-CU-UP packet includes PDU Set information at block 1004, the flow proceeds to block 1006. At block 1006, the CU-UP generates a CU-UP-to-DU packet including the DL data packet and the PDU Set information (e.g., event 326). In some implementations, the CU-UP includes the PDU Set information in a header of the CU-UP-to-DU packet.

Otherwise, if the CU-UP determines that the CN-to-CU-UP packet does not include PDU Set information at block 1004, the flow proceeds to block 1008. At block 1008, the CU-UP generates a CU-UP-to-DU packet including the DL data packet. In some implementations, if the CU-UP determines that the CN-to-CU-UP packet does not include PDU Set information, the CU-UP refrains from including PDU Set information in the CU-UP-to-DU packet. The flow proceeds to block 1010 from block 1006 as well as block 1008. At block 1010, the CU-UP transmits the CU-UP-to-DU packet to a DU (e.g., event 326).

FIG. 10B is a flow diagram of an example method 1000B similar to the method 1000A, except that the method 1000B includes blocks 1005 and 1007 instead of block 1006. As such, the CU-UP generates second PDU Set information based on the first PDU Set information. In particular, if the CU-UP determines that the CN-to-CU-UP packet includes first PDU Set information at block 1004, the flow proceeds to block 1005. At block 1005, the CU-UP generates second PDU Set information based on the first PDU Set information (e.g., event 326). At block 1007, the CU-UP generates a CU-UP-to-DU packet including the DL data packet and the second PDU Set information (e.g., event 326). In some implementations, the CU-UP includes the second PDU Set information in a header of the CU-UP-to-DU packet.

FIG. 11 is a flow diagram of an example method 1100 for performing PDU Set-based QoS handling, implemented by a CU-UP (e.g., the CU-UP 172B of the base station 104) communicating with a DU (e.g., DU 174) and/or CN (e.g., CN 110).

The method 1100 begins at block 1102, where the CU-UP receives a CN-to-CU-UP packet including a DL data packet and PDU Set information from a CN (e.g., event 326). At block 1104, the CU-UP transmits a CU-UP-to-DU packet including the DL data packet and excluding the PDU Set information to a DU (e.g., event 326). In some implementations, the CU-UP refrains from including PDU Set information in a CU-UP-to-DU packet transmitted to the DU. In one implementation, the CU-UP does so because the CU-UP does not support PDU Set information. In another implementation, the CU-UP does so because the DU does not support PDU Set information.

Examples and implementations described for FIG. 9A can apply to FIGS. 10A, 10B, and 11. In some implementations, FIGS. 9A-11 apply to a CU (e.g., the CU 172). In such implementations, CU-CP functions and CU-UP functions are integrated or implemented on the same hardware. In such cases, “CU-UP” described above can be replaced by “CU”.

The following list of examples reflects a variety of the embodiments explicitly contemplated by the present disclosure.

Example 1. A method in a radio access network (RAN) node for configuring protocol data unit (PDU) quality of service (QOS), the method comprising: receiving, at a control plane (CP) entity of the RAN node from a core network (CN), first QoS parameters for a PDU set to be delivered to a UE; and providing, by the CP entity to a user plane (UP) entity of the RAN node, second QoS parameters based on the first QoS parameters.

Example 2. The method of example 1, wherein the receiving of the QoS parameters includes receiving, from the CN, a request for resources for a PDU session with which the PDU set is associated.

Example 3. The method of example 2, wherein the request for resources indicates a QoS flow to which the PDU set pertains.

Example 4. The method of any of the preceding examples, wherein the RAN node is a central unit (CU) of a distributed base station that further includes a distributed unit (DU).

Example 5. The method of any of the preceding examples, further comprising generating the second QoS parameters based on the first QoS parameters in view of one or more of: (i) a latency of a connection between the CP entity and the DU, (ii) data processing latency of the UP entity, or (iii) data processing latency of the DU.

Example 6. The method of any of examples 1-4, further comprising setting the second QoS parameters to be identical to the first QoS parameters.

Example 7. The method of any of examples 4-6, further comprising transmitting, from the CP entity to the DU, third QoS parameters based on the first QoS parameters.

Example 8. The method of example 7, further comprising generating the third QoS parameters based on the first QoS parameters in view of one or more of: (i) a latency of a connection between the CP entity and the DU, (ii) data processing latency of the UP entity, or (iii) data processing latency of the DU.

Example 9. The method of any of examples 7, further comprising setting the third QoS parameters to be identical to the first QoS parameters.

Example 10. The method of any of examples 7-9, wherein the transmitting of the third QoS parameters to the DU includes transmitting a request for a context of the UE, the request including the third QoS parameters.

Example 11. The method of any of the preceding examples, wherein the providing of the second QoS parameters to the UP entity comprises including the second QoS parameters in a request for a bearer context related to the UE.

Example 12. The method of example 11, wherein the including of the second QoS parameters in the request for the bearer context is in response to determining that the CP entity received the first QoS parameters.

Example 13. The method of example 12, wherein the including of the second QoS parameters in the request for the bearer context is further in response to determining that the UP entity supports PDU-set-based QoS processing.

Example 14. The method of example 13, wherein the including of the second QoS parameters in the request for the bearer context is further in response to determining that the UE supports PDU-set-based QoS processing.

Example 15. The method of any of the preceding examples, further comprising receiving, from the CN along with the first QoS parameters for a PDU set, QoS parameters unrelated to the PDU set; and providing, to the UP entity along with the second QoS parameters based on the first QoS parameters, the QoS parameters unrelated to the PDU set.

Example 16. The method of any of the preceding examples, wherein the first QoS parameters include one or more of: (i) a PDU Set Delay Budget (PSDB), (ii) PDU Set Error Rate (PSER), or (iii) PDU Set Integrated Handling Information (PSIHI).

Example 17. The method of any of the preceding examples, further comprising: receiving, from the UP entity, a confirmation that the UP entity performs PDU set-based QoS handling according to the second QoS parameters.

Example 18. The method of any of the preceding examples, further comprising receiving, from the UP entity, an indication that the UP entity does not support PDU set-based QoS handling according to the second QoS parameters.

Example 19. A method in a radio access network (RAN) node for configuring protocol data unit (PDU) quality of service (QOS), the method comprising: receiving, at a user plane (UP) entity of the RAN node from a control plane (CP) entity, QoS parameters for a PDU set to be delivered to a UE; and assigning resources for communicating data packets between the UE and a core network (CN) according to the QoS parameters.

Example 20. The method of example 19, wherein the receiving of the QoS parameters includes receiving a request for a bearer context related to the UE.

Example 21. The method of example 20, further comprising transmitting, to the CP entity in response to the request, a response including a confirmation that the UP entity performs PDU set-based QoS handling according to the second QoS parameters.

Example 22. The method of any of examples 19-21, wherein the RAN node is a central unit (CU) of a distributed base station that further includes a distributed unit (DU).

Example 23. The method of any of examples 19-22, further comprising receiving, from the CN, (i) a PDU set that includes a plurality of downlink (DL) data packets, and (ii) a respective PDU set information for each of the plurality of DL data packets.

Example 24. The method of example 23, wherein each PDU set information includes one or more of: (i) a PDU Set Sequence Number, (ii) a PDU Set size, or (iii) a PDU Set Importance indicator.

Example 25. The method of example 23 or 24, further comprising generating, for each of the plurality of DL data packets, a DL PDU including the data packet.

Example 26. The method of example 25, further comprising: grouping two or more of the DL data packets into a PDU set; and transmitting the PDU set to the UE.

Example 27. The method of any of examples 23-26, wherein each of the plurality of DL data packets includes a respective Tunneling Protocol User Plane (GTP-U) packet.

Example 28. The method of example 19, wherein: the RAN node is a CU of a distributed base station that further includes a DU; the method further comprising: receiving, from the CN, a CN-to-CU-UP packet including a DL data packet and PDU Set information, and transmitting, to the DU, a CU-UP-to-DU packet including the DL data packet and the PDU Set information.
Example 29. The method of example 19, wherein: the RAN node is a CU of a distributed base station that further includes a DU; the method further comprising: receiving, from the CN, a CN-to-CU-UP packet including a DL data packet and first PDU set information, and transmitting, to the DU, a CU-UP-to-DU packet including the DL data packet and second PDU set information based on the first PDU set information.

Example 30. A radio access network (RAN) node comprising: a transceiver, and processing hardware configured to implement a method according to any of the preceding examples.

The following additional considerations apply to the foregoing discussion.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “at least one” means “one or more”. In some implementations, “PDU Set-based QoS handling” can be replaced by “PDU Set handling”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

When implemented in software, the techniques can be provided as part of the operating system, a library used by multiple applications, a particular software application, etc. The software can be executed by one or more general-purpose processors or one or more special-purpose processors.

1. A method in a radio access network (RAN) node for configuring protocol data unit (PDU) quality of service (QOS), the method comprising:
receiving, at a control plane (CP) entity of the RAN node from a core network (CN), first QoS parameters for a PDU set to be delivered to a UE; and
providing, by the CP entity to a user plane (UP) entity of the RAN node, second QoS parameters based on the first QoS parameters.

2. The method of claim 1, wherein the receiving of the QoS parameters includes:
receiving, from the CN, a request for resources for a PDU session with which the PDU set is associated, the request for resources indicating a QoS flow to which the PDU set pertains.

3. The method of claim 1, wherein:
the RAN node is a central unit (CU) of a distributed base station that further includes a distributed unit (DU).

4. The method of claim 1, further comprising:
generating the second QoS parameters based on the first QoS parameters in view of one or more of:
(i) a latency of a connection between the CP entity and the DU,
(ii) data processing latency of the UP entity, or
(iii) data processing latency of the DU.

5. The method of claim 3, further comprising:
transmitting, from the CP entity to the DU, third QoS parameters based on the first QOS parameters.

6. The method of claim 5, further comprising:
generating the third QoS parameters based on the first QoS parameters in view of one or more of:
(i) a latency of a connection between the CP entity and the DU,
(ii) data processing latency of the UP entity, or
(iii) data processing latency of the DU.

7. The method of claim 1, wherein:
the providing of the second QoS parameters to the UP entity comprises is in response to at least one of:
(i) determining that the CP entity received the first QoS parameters,
(ii) determining that the UP entity supports PDU-set-based QoS processing, or
(iii) determining that the UE supports PDU-set-based QoS processing.

8. The method of claim 1, further comprising:
receiving, from the CN along with the first QoS parameters for a PDU set, QoS parameters unrelated to the PDU set; and
providing, to the UP entity along with the second QoS parameters based on the first QOS parameters, the QoS parameters unrelated to the PDU set.

9. The method of claim 1, wherein the first QoS parameters include one or more of:
(i) a PDU Set Delay Budget (PSDB),
(ii) PDU Set Error Rate (PSER), or
(iii) PDU Set Integrated Handling Information (PSIHI).

10. A method in a radio access network (RAN) node for configuring protocol data unit (PDU) quality of service (QOS), the method comprising:
receiving, at a user plane (UP) entity of the RAN node from a control plane (CP) entity, QoS parameters for a PDU set to be delivered to a UE; and
assigning resources for communicating data packets between the UE and a core network (CN) according to the QoS parameters.

11. The method of claim 10, wherein:
the receiving of the QoS parameters includes receiving a request for a bearer context related to the UE.

12. The method of claim 10, further comprising:
transmitting, to the CP entity in response to the request, a response including a confirmation that the UP entity performs PDU set-based QoS handling according to the second QoS parameters.

13. The method of claim 10, further comprising:
receiving, from the CN, (i) a PDU set that includes a plurality of downlink (DL) data packets, and (ii) a respective PDU set information for each of the plurality of DL data packets.

14. The method of claim 13, wherein each PDU set information includes one or more of:
(i) a PDU Set Sequence Number,
(ii) a PDU Set size, or
(iii) a PDU Set Importance indicator.

15. A radio access network (RAN) node comprising:
a transceiver, and processing hardware, the RAN node configured to configure protocol data unit (PDU) quality of service (QOS), including:
receive, at a control plane (CP) entity of the RAN node from a core network (CN), first QoS parameters for a PDU set to be delivered to a UE; and
provide, by the CP entity to a user plane (UP) entity of the RAN node, second QoS parameters based on the first QoS parameters.

16. The RAN node of claim 15, wherein to receive the QoS parameters, the RAN node is configure to:
receive, from the CN, a request for resources for a PDU session with which the PDU set is associated, the request for resources indicating a QoS flow to which the PDU set pertains.

17. The RAN node of claim 15, wherein:
the RAN node is a central unit (CU) of a distributed base station that further includes a distributed unit (DU).

18. The RAN node of claim 17, further configured to generate the second QoS parameters based on the first QoS parameters in view of one or more of:
(i) a latency of a connection between the CP entity and the DU,
(ii) data processing latency of the UP entity, or
(iii) data processing latency of the DU.

19. The RAN node of claim 15, wherein:
the providing of the second QoS parameters to the UP entity comprises is in response to at least one of:
(i) determining that the CP entity received the first QoS parameters,
(ii) determining that the UP entity supports PDU-set-based QoS processing, or
(iii) determining that the UE supports PDU-set-based QoS processing.

20. The RAN node of claim 15, further configured to:
receive, from the CN along with the first QoS parameters for a PDU set, QoS parameters unrelated to the PDU set; and
provide, to the UP entity along with the second QoS parameters based on the first QOS parameters, the QoS parameters unrelated to the PDU set.
